(19) United States
(12) Patent Application Publication
(10) Pub. No.: US 2003/0061365 A1
(43) Pub. Date: Mar. 27, 2003

(54) Service-to-service communication for network services

(75) Inventors: Steven D. White, Bellevue, WA (US); Lijiang Fang, Sammamish, WA (US)

Correspondence Address: MICHALIK & WYLIE PLLC, Suite 103, 14645 Bel-Red Road, Bellevue, WA, 98007, US

(73) Assignee: Microsoft Corporation

(21) Appl. No.: 10/033,177

(22) Filed: Oct. 22, 2001

Related U.S. Application Data
(60) Provisional application No. 60/275,809, filed on Mar. 14, 2001.

(51) Int. Cl. G06F 15/16

(52) U.S. Cl. 709/229

(57) ABSTRACT

A robust and efficient service-to-service communications protocol that handles change information in an identity-centric data access architecture. The protocol enables the automatic publication and subscription by services of changes made to data of millions of users. The protocol is role-based in that a user controls the users that can subscribe for the user's data changes and is efficient in that data is change data for users are combined and batched, and robust to handle failure scenarios. In one implementation, the a “publisher” refers to the .NET MyServices service which is the source of the data, while a “subscriber” refers to the .NET MyServices service that receives the data. The publisher and subscriber maintain updated information about each other's users in order to accomplish selective data communication and filtering. To provide robustness, requests are acknowledged, and until acknowledged, retried regularly for awhile, with delays between regular retries.

### CROSS REFERENCE TO RELATED APPLICATIONS

The present application claims priority from co-pending U.S. provisional application serial No. 60/275,809, filed Mar. 14, 2001 and entitled “Identity-Based Service Communication Using XML Messaging Interfaces”, which is hereby incorporated herein by reference in its entirety. The present application is related to U.S. patent application Ser. No. ______ entitled Schema-Based Services for Identity-Based Data Access, filed concurrently herewith on Oct. 22, 2001.

### COPYRIGHT DISCLAIMER

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The invention relates generally to computer network services for user data access, and more particularly to systems, methods and data structures for communication between the services.

### BACKGROUND OF THE INVENTION

There are many types of data that users need to manage and otherwise access. For example, users keep word processing documents, spreadsheet documents, calendars, telephone numbers and addresses, e-mail messages, financial information and so on. In general, users maintain this information on various personal computers, hand-held computers, pocket-sized computers, personal digital assistants, mobile phones and other electronic devices. In most cases, a user's data on one device is not accessible to another device, without some manual synchronization process or the like to exchange the data, which is cumbersome. Moreover, some devices do not readily allow for synchronization. For example, if a user leaves his cell phone at work, he has no way to get his stored phone numbers off the cell phone when at home, even if the user has a computing device or similar cell phone at his disposal. As is evident, these drawbacks result from the separate devices each containing their own data.

Corporate networks and the like can provide users with remote access to some of their data, but many users do not have access to such a network. For many of those that have access, connecting to a network with the many different types of devices, assuming such devices can even connect to a network, can be a complex or overwhelming problem.

Moreover, even if a user has centrally stored data, the user needs the correct type of device running the appropriate application program to access that data. For example, a user with a PDA that runs a simple note taking application program ordinarily will not be able to use that program to open documents stored by a full-blown word processing program at work. In general, this is because the data is formatted and accessed according to the way the application program wants it to be formatted.

What is needed is a model wherein data is centrally stored for users, with a set of services that control access to the data with defined methods, regardless of the application program and/or device. When accessed, the data for each service should be structured in a defined way that complies with defined rules for that data, regardless of the application program or device that is accessing the data. Moreover, the data should be controllable by a user so as to automatically adjust for changes made thereto by other users. This model should scale and interrelate the data of millions of users in virtually any combination, in a highly efficient robust manner.

### SUMMARY OF THE INVENTION

Briefly, the present invention provides a set of services for central (e.g., Internet) access to per-user data, based on each user's identity, with a service-to-service communications protocol that handles change information for millions of users. The protocol enables the automatic publication and subscription by services of changes made to data. The protocol is role-based in that a user controls the users that can subscribe for the user's data changes. The protocol is efficient in that data is change data for users are combined and batched, and robust to handle failure scenarios.

In one implementation, the a “publisher” refers to the .NET MyServices service which is the source of the data, while a “subscriber” refers to the .NET MyServices service that receives the data. In general, SSCP is a generic way for a .NET MyServices service to publish data changes to another .NET MyServices service. To ensure robustness in such an environment of transient network and/or service failures, the present invention establishes common message formats, and an accepted set of primitives that the parties involved understand, so that transactions among them follow predictable logical sequences. SSCP also establishes handshaking procedures with ACK to handle lost messages.

In order to accomplish such selective data communication and filtering, the publisher maintains information about the identifier (ID) of the subscribing users. Also, for each subscribing user, the publisher maintains the ID of the user's data for which they have subscribed. The publisher also maintains information regarding the role of the subscribing user. In order for the publisher to keep this information current, the subscriber notifies the publisher whenever one of its users wants to unsubscribe or add a new subscription. SSCP provides for transmission of subscription updates from subscriber to publisher using the same robust mechanism as are used for transmitting data changes.

To provide robustness, each request from a sender should have a response from the receiver. If the message fails to reach the receiver, e.g. due to transient network and/or service failure, it is resent during the next update interval. This resend process is repeated until a response is received, with a specified number of such retries performed, after which no further attempts are made for an appropriately longer time. More subtle types of failures also need to be handled. For example, consider a publisher sending a request to the subscriber, informing it of the change in a stored profile. The subscriber ordinarily receives and processes the request, and sends a response to the publisher. However, if the network connection between the subscriber and the publisher has a transient failure and the response fails to reach the publisher, the publisher will re-send its request it request during the next update interval. In SSCP, the subscriber recognizes that this is a redundant request, and that it has already been processed, whereby the subscriber acknowledges the request again, but does not process it.

For efficiency, because a typical service manages enormous amounts of data, partitioned over millions of users and the source data will be almost constantly changing, the protocol batches multiple requests and send them periodically. To this end, a protocol handler at the service periodically wakes up after a specified interval and sends the batched messages. Moreover, if a catastrophic failure (such as loss of power) occurs, this state data regarding the messages to send should not be lost, so data pertaining to protocol state should be stored in a durable manner, e.g., persisted to a hard disk. To implement SSCP, protocol handlers the publisher and subscriber track of several pieces of information, such as in respective tables.

To send a request or a response, the service needs to know where the target is located, and, to ensure proper handling of the number of retries for a particular service, the handler needs to keep track of how many retries have been done. This information is kept in a connections table. A publications table is used by the publisher to track the users across the services that have subscriptions with it. The publisher includes a publications queue table that is used by the publisher for batching requests until the protocol handler sends the requests at an update interval. The publisher also retries requests for which a response has not been received, and thus tracks messages that need to be sent for the first time, or need to be resent, in the publications queue table.

The subscriber service includes subscriptions table to track of its subscriptions that are in effect. When a subscription is added, the subscribing user specifies the user's identity of the user whose data he or she wants to subscribe to. A subscriptions queue table is used by the subscriber to batch its requests for sending by the protocol handler at the update interval. Also, the subscriber is required to retry requests for which a response has not been received, and thus keeps track of messages that need to be sent for the first time, or need to be resent, which is also done in the subscriptions queue table.

Moreover, the amount of information that is transmitted from one service to another is significantly reduced in SSCP because the change information for one user at a publisher service that is subscribed to by multiple users at a subscriber service who are assigned the same role at the publishing service, are aggregated into a single message. In other words, the publisher operates in a fan-in model to put change information together based on their roles, rather than separate it per user recipient, and leaves it up to the subscriber to fan the information out to the appropriate users.

Other benefits and advantages will become apparent from the following detailed description when taken in conjunction with the drawings, in which:

### BRIEF DESCRIPTION OF THE DRAWINGS

FIG. 1 is a block diagram representing an exemplary computer system into which the present invention may be incorporated;

FIG. 2 is a block diagram representing a generic data access model;

FIG. 3 is a representation of services for identity-based data access;

FIG. 4 is a block diagram representing a schema-based service for accessing data arranged in a logical content document based on a defined schema for that service;

FIGS. 5-7 are block diagram generally representing publishers and subscribers interconnected via a service-to-service communication protocol in accordance with one aspect of the present invention;

FIGS. 8-16B comprise flow diagrams generally representing operation of the service-to-service communication protocol in accordance with one aspect of the present invention; and

FIGS. 17-18 are block diagram generally representing publishers and subscribers interconnected via a service-to-service communication protocol in accordance with an alternative aspect of the present invention; and

FIGS. 19-20 are block diagram generally representing models in which the service-to-service communication protocol may be implemented, in accordance with an aspect of the present invention.

### DETAILED DESCRIPTION

Exemplary Operating Environment

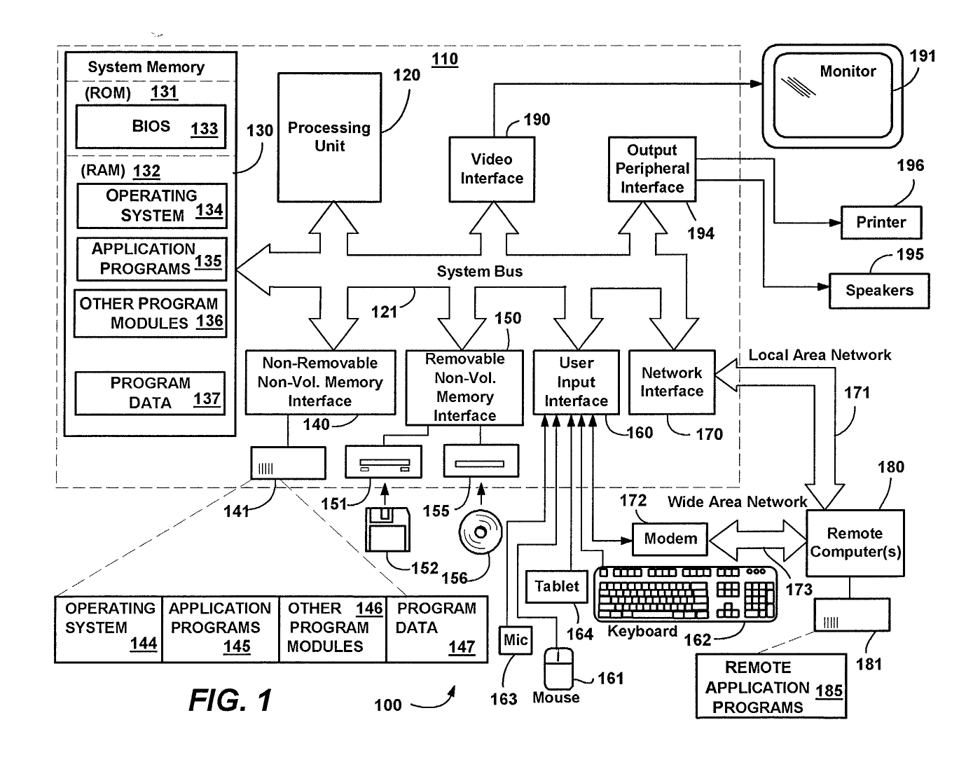

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, that perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet. For example, in the present invention, the computer system 110 may comprise source machine from which data is being migrated, and the remote computer 180 may comprise the destination machine. Note however that source and destination machines need not be connected by a network or any other means, but instead, data may be migrated via any media capable of being written by the source platform and read by the destination platform or platforms.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Data Access Model

The present invention generally operates in an architecture/platform that connects network-based (e.g., Internet-based) applications, devices and services, and transforms them into a user's personal network which works on the user's behalf, and with permissions granted by the user. To this end, the present invention is generally directed to schema-based services that maintain user, group, corporate or other entity data in a commonly accessible virtual location, such as the Internet. The present invention is intended to scale to millions of users, and be stored reliably, and thus it is likely that a user's data will be distributed among and/or replicated to numerous storage devices, such as controlled via a server federation. As such, while the present invention will be generally described with respect to an identity-centric model that enables a user with an appropriate identity and credentials to access data by communicating with various core or other services, it is understood that the schema-based services described herein are arranged for handling the data of millions of users, sorted on a per-user-identity basis. Note that while “user” is generally employed herein for simplicity, as used herein the term “user” is really a substitute for any identity, which may be a user, a group, another entity, an event, a project, and so on.

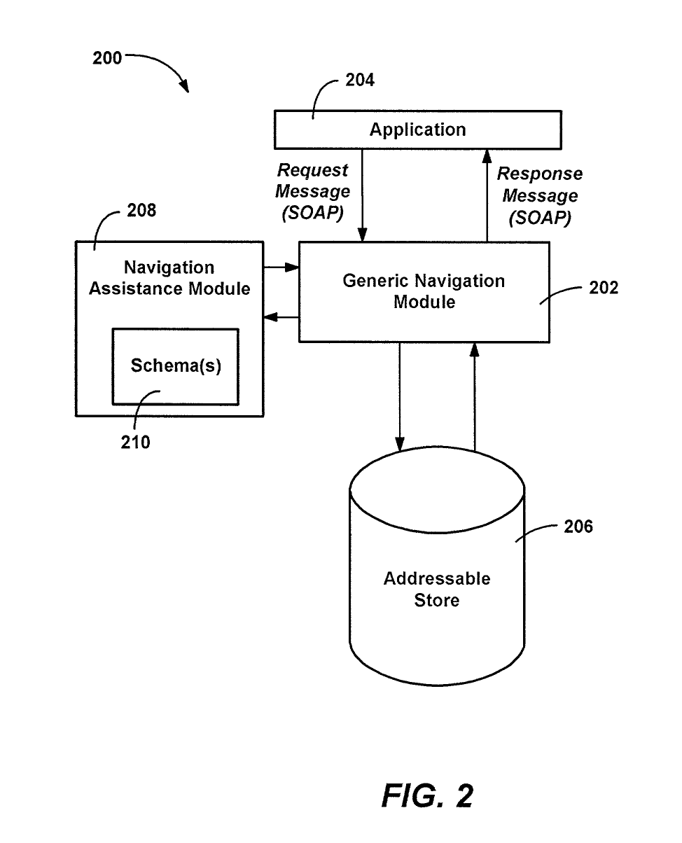

As generally represented in FIG. 2, a data access model 200 of FIG. 2 illustrates a generic navigation module 202 through which applications 204 and the like may access a wide variety of identity-based data, such as maintained in an addressable store 206. To access the data, a common set of command methods may be used to perform operations on various data structures that are constructed from the data in the addressable store 206, even though each of those data structures may represent different data and be organized quite differently. Such command methods may describe generic operations that may be desired on a wide variety of data structures. Such operations may include, for example, insert, delete, replace, update, query or changequery operations.

The data is arranged according to various schemas, with the schemas corresponding to identity-based services through which users access their data. As used herein, a “schema” generally comprises a set of rules that define how a data structure may be organized, e.g., what elements are supported, in what order they appear, how many times they appear, and so on. In addition, a schema may define, via color-coding or other identification mechanisms, what portions of an XML document (that corresponds to the data structure) may be operated on. Examples of such XML documents are described below. The schema may also define how the structure of the XML document may be extended to include elements not expressly mentioned in the schema.

As will be understood below, the schemas vary depending on the type of data they are intended to organize, e.g., an email-inbox-related schema organizes data differently from a schema that organizes a user's favorite websites. Further, the services that employ schemas may vary. As such, the generic navigation module 202 has associated therewith a navigation assistance module 208 that includes or is otherwise associated with one or more schemas 210. As will be understood, a navigation assistance module 208 as represented in FIG. 2 corresponds to one or more services, and possesses the information that defines how to navigate through the various data structures, and may also indicate what command methods may be executed on what portions of the data structure. Although in FIG. 2 only one navigation assistance module 208 is shown coupled to the generic navigation module 202, there may be multiple navigation assistance modules that may each specialize as desired. For example, each navigation assistance module may correspond to one service. Moreover, although the navigation assistance module 208 is illustrated as a separate module, some or all of the operations of the navigation assistance module 208 may be incorporated into the generic navigation module 202, and vice versa. In one embodiment, the various data structures constructed from the schema and addressable store data may comprise XML documents of various XML classes. In that case, the navigation assistance module 208 may contain a schema associated with each of the classes of XML documents.

A number of schema-based services facilitate data access based on the identity of a user. Preferably, the user need not obtain a separate identity for each service, but rather obtains a single identity via a single set of credentials, such as with the Microsoft® Passport online service. With such an identity, a user can access data via these services from virtually any network connectable device capable of running an application that can call the methods of a service.

Services and Schemas

“.NET My Services” comprises identity-centric services which may be generally implemented in XML (eXtensible Markup Language) Message Interfaces (XMIs). While the present invention will be described with respect to XML and XMI, it can readily be appreciated that the present invention is not limited to any particular language or set of interfaces. The .NET My Services model essentially corresponds to one implementation of the generic data access model 200 of FIG. 2.

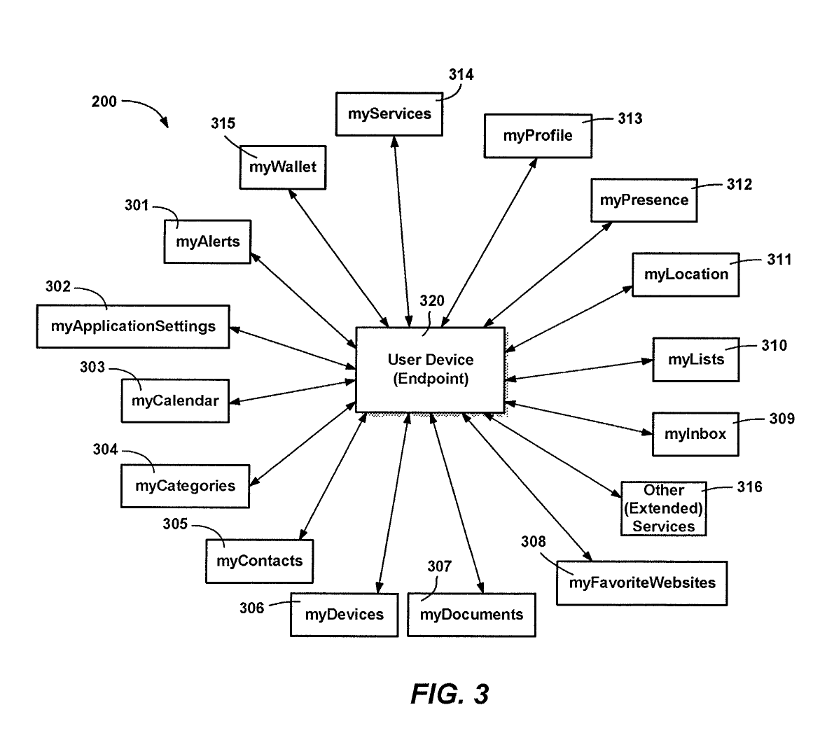

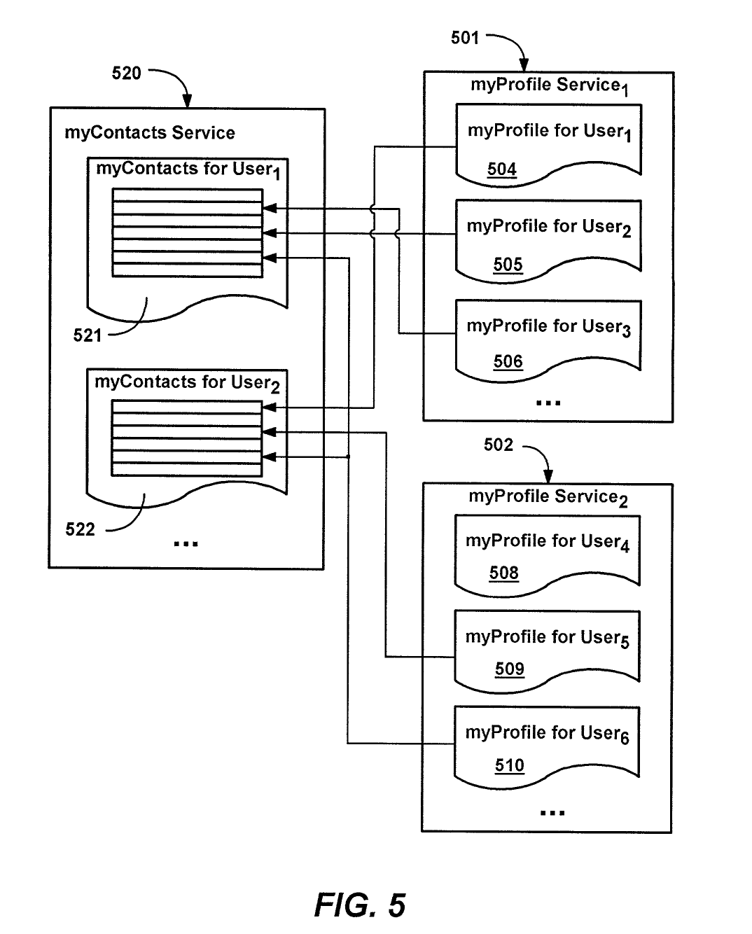

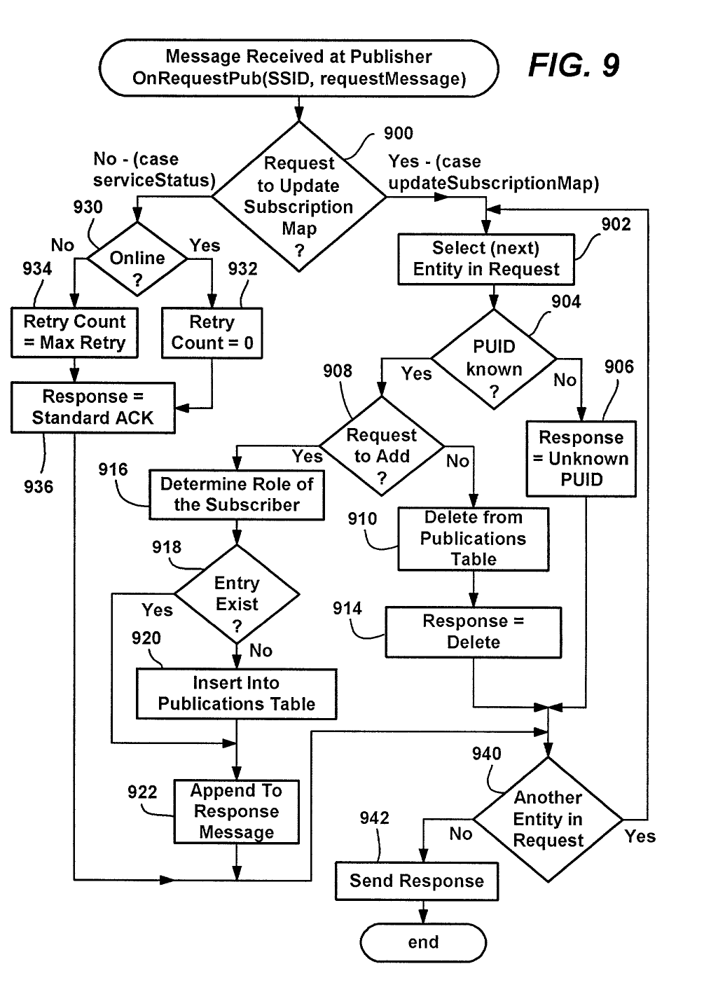

As generally represented in FIG. 3, .NET My Services 300 is implemented as a set of Web services 301-316, each bound to a .NET Identity (PUID, such as a Passport® unique identifier similar to a globally unique identifier when Passport® is the authentication service). The services 301-316 can communicate with one another via a service-to-service communications protocol (SSCP), described below with respect to FIGS. 5-23. As also described below, each service presents itself as a set of XML documents that can be manipulated from an application program 202 (FIG. 2) or the like using a set of standard methods and domain-specific methods. To this end, a user device 320 (endpoint) running such application programs connects a user's applications to the services, and the data controlled by those services, such as over the Internet or an Intranet, such as over the Internet or an Intranet. Note that endpoints can be client devices, applications or services. In keeping with the present invention, virtually any device capable of executing software and connecting to a network in any means may thus give a user access to data that the user is allowed to access, such as the user's own data, or data that a friend or colleague has specified as being accessible to that particular user.

In general, a .NET Identity is an identifier assigned to an individual, a group of individuals, or some form of organization or project. Using this identifier, services bound to that identity can be located and manipulated. A general effect is that each identity (e.g., of a user, group or organization) has tied to it a set of services that are partitioned along schema boundaries and across different identities. As will be understood, the XML-document-centric architecture of .NET My Services provides a model for manipulating and communicating service state that is very different from prior data access models. The XML-document-centric approach, in conjunction with loose binding to the data exposed by the services, enables new classes of application programs. As will also be understood, the .NET My Services model 300 presents the various services 301-316 using a uniform and consistent service and method model, a uniform and consistent data access and manipulation model, and a uniform and consistent security authorization model.

In a preferred implementation, the .NET My Services model 300 is based upon open Internet standards. Services are accessed by means of SOAP (Simple Object Access Protocol) messages containing an XML payload. Service input and output is expressed as XML document outlines, and each of these document outlines conform to an XML schema document. The content is available to a user from the interaction with the .NET My Services service endpoint 320.

One significant aspect of the present invention is that a schema (or description) essentially describes a web service, such as in XML. More particularly, a service author begins to write a web service by defining an XML schema that defines what the data model looks like, e.g., the supported elements, their relative ordering, how many times they appear, and other similar definitions, as will become apparent below. This service definition also applies to an author determining what roles and methods are supported, e.g., which operations are supported, and the extent of the data that can be returned for each method. Another way of stating this concept is that the author starts by building a complete definition of a service, such as in XML, and specifies the verbs (methods) that an application will use to talk to it.

At this point, the service author has an XML definition that has been declared, and this declarative definition may be run through a compilation process, resulting in a fully operational service. It should be noted that a general purpose interpreter-like mechanism already exists that, when fed one of these declarative XML definitions, adapts to the declarative XML definitions, thereby knowing what to do and how to act. From that point on a service exists that is capable of operating. In a simple service (e.g., with no domain-specific methods or complex logic), no new code needs to be written to provide such an operational service. As will be understood, such authoring of a service without coding is possible due to the data driven model of the present architecture.

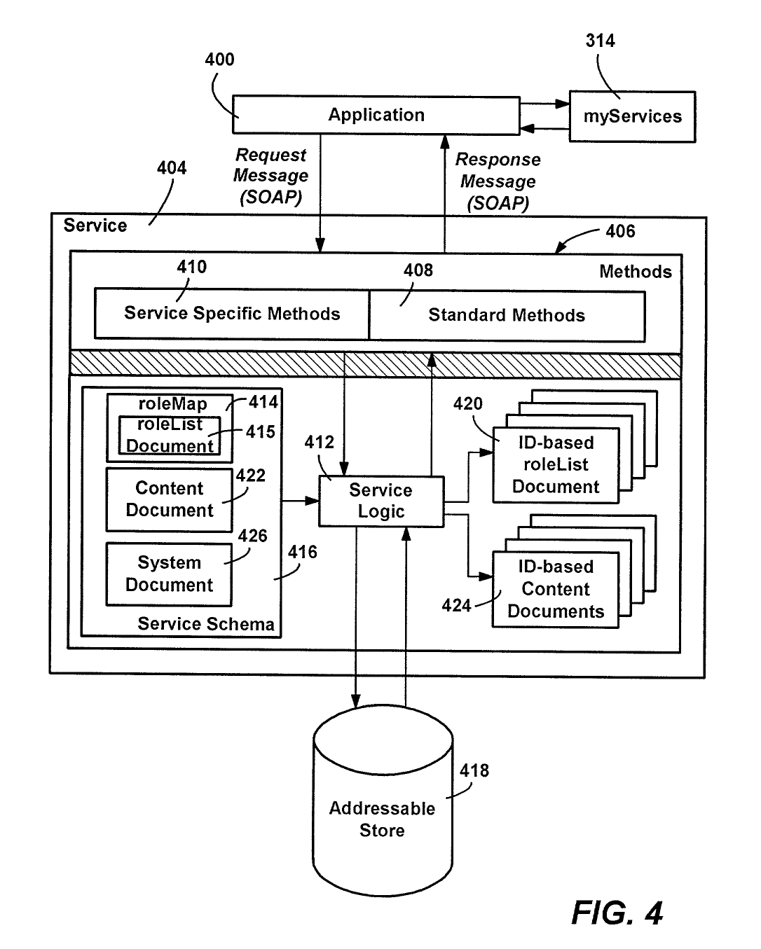

Turning to FIG. 4, in the .NET My Services model, an application 400 requests performance of a method that operates on data structures, in a manner that is generic with respect to the type of data structure being operated upon and without requiring dedicated executable code for manipulating data structures of any particular data type. To this end, the application first contacts a special myServices service 314 to obtain the information needed to communicate with a particular service 404, through a set of methods 406 of that service 404. For example, the needed information received from the myServices service 314 includes a URI of that service 404. Note that the service 404 may correspond to essentially any of the services represented in FIG. 3.

The service 404 includes or is otherwise associated with a set of methods 406 including standard methods 408, such as to handle requests directed to insert, delete, replace, update, query or changequery operations on the data. The set of methods of a particular service may also include service specific methods 410. In general, the only way in which an application can communicate with a service are via that service's methods.

Each service includes service logic 412 for handling requests and providing suitable responses. To this end, the service logic performs various functions such as authorization, authentication, and signature validation, and further limits valid users to data which they are permitted to access. The security aspect of a service is not discussed herein, except to note that in general, for otherwise valid users, the user's identity determines whether a user can access data in a requested manner. To this end, a roleMap 414 comprising service-wide roleList document templates 415 and scopes (e.g., part of the overall service's schema 416) in conjunction with user-based data maintained in an addressable store 418 determines whether a particular requested method is allowed, e.g., by forming an identity-based roleList document 420. If a method is allowed, the scope information in the roleMap 414 determines a shape of data to return, e.g., how much content is allowed to be accessed for this particular user for this particular request. The content is obtained in accordance with a content document 422 in the service's schema 416 and the actual user data corresponding to that content document in the addressable store 418. In this manner, a per-identity shaped content document 424 may be essentially constructed for returning to the user, or for updating the addressable store, as appropriate for the method. Note that FIG. 4 includes a number of ID-based roleList documents and ID-based content documents, to emphasize that the service 406 is arranged to serve multiple users. Also, in FIG. 4, a system document 426 is present as part of the schema 416, as described below.

Returning to FIG. 3, in one implementation, access to .NET My Services 300 is accomplished using SOAP messages formatted with .NET My Services-specific header and body content. Each of the .NET My Services will accept these messages by means of an HTTP POST operation, and generate a response by “piggy-backing” on the HTTP Response, or by issuing an HTTP POST to a .NET My Services response-processing endpoint 320. In addition to HTTP as the message transfer protocol, .NET My Services will support raw SOAP over TCP, a transfer protocol known as Direct Internet Message Encapsulation (or DIME). Other protocols for transferring messages are feasible.

Because .NET My Services are accessed by protocol, no particular client-side binding code, object models, API layers, or equivalents are required, and are thus optional. The .NET My Services will support Web Services Description Language (WSDL). It is not mandatory that applications wishing to interact with .NET My Services make use of any particular bindings, and such bindings are not described herein. Instead, the present invention will be generally described in terms of messages that flow between requestors of a particular service and the service endpoints. In order to interact with .NET My Services, a service needs to format a .NET My Services message and deliver that message to a .NET My Services endpoint. In order to format a message, a client needs to manipulate XML document outlines, and typically perform some simple, known (public-domain) cryptographic operations on portions of the message.

In accordance with one aspect of the present invention, and as described in FIG. 4 and below, in one preferred implementation, each .NET My Services service presents three logical XML documents, a content document 422, roleList document 415 (of the roleMap 414), and a system document 426. These documents are addressable using .NET My Services message headers, and are manipulated using standard .NET My Services methods. In addition to these common methods, each service may include additional domain-specific methods. For example, as described below, the “.NET Calendar” service 303 might choose to expose a “getFreeBusy” method rather than expose free/busy as writeable fragments in the content document.

Each .NET MyServices service thus logically includes a content document 422, which in general is the main, service-specific document. The schema for this document 422 is a function of the class of service, as will become apparent from the description of each service's schema below. For example, in the case of the .NET Calendar service 303, the content document presents data in the shape dictated by the .NET My Services .NET Calendar schema, whereas in the case of the “.NET FavoriteWebSites” service 308, the content document presents data in the shape dictated by the .NET My Services .NET FavoriteWebSites schema.

Each service also includes a roleList document 415 that contains roleList information, comprising information that governs access to the data and methods exported by the service 404. The roleList document is manipulated using the .NET My Services standard data manipulation mechanisms. The shape of this document is governed by the .NET My Services core schema's roleListType XML data type.

Each service also includes a system document 426, which contains service-specific system data such as the roleMap, schemaMap, messageMap, version information, and service specific global data. The document is manipulated using the standard .NET My Services data manipulation mechanism, although modifications are limited in a way that allows only the service itself to modify the document. The shape of this system document 426 may be governed by the system document schema for the particular service, in that each service may extend a base system document type with service specific information. For purposes of simplicity herein, the base system document is described once, rather than for each service, with only those services having extended service specific information separately described. Notwithstanding, it should be understood that each service includes at least the base system portion in its system document.

As is understood, the present invention is generally directed to schemas, which in general comprise a set of rules or standards that define how a particular type of data can be structured. By the schemas, the meaning of data, rather than just the data itself, may be communicated between computer systems. For example, a computer device may recognize that a data structure that follows a particular address schema represents an address, enabling the computer to “understand” the component part of an address. The computer device may then perform intelligent actions based on the understanding that the data structure represents an address. Such actions may include, for example, the presentation of an action menu to the user that represents things to do with addresses. Schemas may be stored locally on a device and/or globally in the federation's “mega-store.” A device can keep a locally stored schema updated by subscribing to an event notification service (in this case, a schema update service) that automatically passes messages to the device when the schema is updated. Access to globally stored schemas is controlled by the security infrastructure.

Service to Service Communication

The various .NET MyServices services described above are loosely coupled services, and have the ability to share data with each other. It is thus possible for the data to be stored and managed by one service, regardless of how many services or applications make use of the data.

Generally, there are at least two ways that this data sharing can take place (assuming that appropriate security constraints are satisfied), a first of which is that one service that wants data queries another service that has the data, i.e., a pull model. Alternatively, a service that wants data can informs the service that has the data to send it the current copy of the data and places an outstanding request to send it any changes to that data. The said changes are sent asynchronously. This is a push model.

The .NET services defines verbs such as query, update, etc., which can be used as a basis for the pull data pipe between services. But for reasons of bandwidth optimization and robustness, the push model turns out to be a better choice for service to service communication. To this end, and in accordance with one aspect of the present invention, a service-to-service communication protocol (SSCP) is provided that supports a push model of data sharing between .NET MyServices services.

As used herein, a “publisher” refers to the .NET MyServices service which is the source of the data, while a “subscriber” refers to the .NET MyServices service that receives the data. In general, SSCP is a generic way for a .NET MyServices service to publish data changes to another .NET MyServices service. For example, SSCP does not make any assumptions on what data is being published, and the data may be from any source, e.g., .NET Contacts, .NET Profile, .NET Presence, .NET Inbox and so forth. SSCP also does not make any assumptions on which services can be publishers and which services can be subscribers. With SSCP, the same service can be a publisher and subscriber, publishers can publish to multiple subscribers and subscribers can subscribe to multiple publishers.

In general, a given service can publish/subscribe to a static list of other services, e.g., NET Contacts (alternatively referred to as myContacts) may be configured with the list of services (e.g., .NET Profile/myProfile, .NET Inbox/myInbox and so on) that it wants to publish to and/or subscribe from, and this list will ordinarily not change. However, although the services are static, the instances of services are not. For example, once a service A is configured with the ability to publish or subscribe from service B, service A can do so with any instance of B For security reasons and the like, only .NET services can participate in data communication over SSCP.

For purposes of explanation, the present invention will be described with respect to a number of examples. However, while these examples correspond to likely scenarios and implementations, it is understood that the present invention is not limited to the particular examples used, but rather works with essentially any service's data communication with essentially any other service.

By way of a first example, consider a scenario of an email whitelist, which is a list of addresses that are allowed to send email to a particular recipient. Email from people belonging to the whitelist is put in the inbox; all other email is sent to a Junk Mail folder or to the deleted folder. Sometimes, the whitelist of a user is the same as her contact list - this would be the case with the .NET Inbox service. Even if this is not the case, it is fairly straightforward to store a whitelist in .NET Contacts by the use of a categorization mechanism present in NET My Services.

Using the pull model, a white list can be implemented in a brute force fashion by arranging the .NET Inbox service (e.g., directly or in conjunction with an application program) to look at the sender address whenever a message is received. The .NET Inbox service may query the user's .NET Contacts service to see if the sender is in the contact list, whereby depending on the result of the query, .NET Inbox service either puts the message in the Inbox or puts it in the Junk Mail folder. As can be understood, this approach has obvious performance and scaling problems, as it is impractical or impossible for any service that handles hundreds of millions of email messages every day to use such a model; the sheer volume of traffic between .NET Inbox and .NET Contacts would bring down both the services.

In keeping with the present invention, a superior approach is for the .NET Inbox service to maintain a local copy of the whitelist, and subscribe to the .NET Contacts data of every user that has enabled a Junk Mail filter. Whenever changes occur to the whitelist, the .NET Contacts service uses SSCP to send those changes to the .NET Inbox service. Because the .NET Inbox service has a local copy of the white list, the performance/scaling issues are avoided, and any traffic between the .NET Inbox service and the .NET Contacts service occurs only when the whitelist changes in the .NET Contacts service, the .NET Inbox service subscribes to the .NET Contacts service document of a new user (or a user who has newly activated her junk mail filters) or the .NET Inbox service asks the .NET Contacts service to delete the subscription of a currently subscribed user.

Whitelists represent a simple publish-subscribe scenario in that user id's of the publisher and subscriber are the same. There is no requirement to take into account the role of the subscriber in the publisher's document, the assumption being that the same id plays the “owner” role on both sides of this communication channel. A more complex example is that of Live Contacts. Among the contacts managed by the .NET Contacts service, it is likely that many are users of .NET My Services. As a result, these contacts will have a .NET Profile service which manages data in their profile. In general, the data stored in a contact record of NET Contacts is a subset of what is stored in that contact's profile, the boundaries of the said subset being determined by the role of the subscriber in the originating profile's role list. Thus, it is natural for .NET Contacts service to subscribe to the .NET Profile service to get the data for many of the contacts that it manages. From the other perspective, the .NET Profile service publishes its data to the .NET Contacts service.

In accordance with one aspect of the present invention, because, .NET Profile of this user publishes any changes to the .NET Contacts service of each appropriately authorized user (e.g., in a trusted circle of friends), whenever a user updates his profile, such as to change his or her email address, that change becomes immediately visible to the users in his or her trusted circle when they look up his email via their .NET Contacts service. Note that SSCP works across realms as well as between services in the same realm, e.g., a subscriber contacts service in a realm corresponding to MSN.com will be able to receive published changes from a publisher profile service in a realm corresponding to a provider such as XYZ.com, as well as from an MSN.com profile service.

The present invention favors the push model over the pull model. While the pull model is usually simpler, its conceivable use is limited to data pipes with low traffic and/or few subscribers. However, the push model, while a little more involved, provides a bandwidth optimized, robust data pipe and is ideal for high-traffic and/or large number of subscribers. To ensure robustness in such an environment of transient network and/or service failures, the present invention establishes common message formats, and an accepted set of primitives that the parties involved understand, so that transactions among them follow predictable logical sequences. SSCP also establishes handshaking procedures with ACK to handle lost messages.

FIG. 5 provides a representation of an example publisher-subscriber relationship. In FIG. 5, there are two .NET Profile services 501 and 502, each managing the profiles of three users, 504-506 and 508-510, respectively. There is one instance of a .NET Contacts service 520 shown in FIG. 5, which manages the contact information sets (521 and 522) of two users. As is understood, in an actual implementation, each of these services 501, 502 and 520 will typically manage the data for hundreds of millions of users. Note that for each user, access to the various contact information sets is on a per-identifier basis, e.g., a contact that is specified as a friend by a user may be assigned different access rights to the user's contacts than a contact that is specified as an associate by the same user.

As represented by the logical connections (shown in FIG. 5 as arrows) between the identity-based contacts and the identify-based profiles, the .NET Contacts service 520 has subscriptions in two different .NET Profile services, namely 501 and 502. Similarly, it is likely that a given publisher will publish to multiple subscribers. Note that a single service may act both as a subscriber and a publisher, e.g., in the whitelist example above, the .NET Contacts service is a publisher, while in the Live Contacts example, .NET Contacts service is a subscriber.

As represented in FIG. 5, when the profile information for User6 (maintained in .NET Profile 510) changes, change information is published by the .NET Profile service2 502 to the .NET Contacts service 520, as both User1 and User2 have subscribed for the service. Note that in FIG. 5 this is indicated by the arrow to a particular contact for each user. Note that within the context of a given topic, the data flows from the publisher to the subscriber. As also represented by the arrows in FIG. 5, only User2 has subscribed for profile changes of User5. Thus, when User5's profile is changed, the .NET Profile service 502 will publish the changes only to User2's .NET Contacts, and User1's .NET Contacts does not see these changes.

Returning to User6, consider that User1's role in User6's .NET Profile is that of an associate, while the role of User2 is that of a friend. When .NET Profile publishes the data, it sends data visible to an associate to User1, and data visible to a friend to User2. To this end, SSCP sends changes only to subscribed users within a subscribing service, and determines the role of each subscribing user and filters the data based on the role. Furthermore, if User3's role was also that of an associate, then only one copy of the associate data would be sent to the subscribing service, thus optimizing usage of network resources.

In order to accomplish such selective data communication and filtering, the publisher maintains information about the identifier (ID) of the subscribing users, (e.g., User1, User2). Also, for each subscribing user, the publisher maintains the ID of the user's data for which they have subscribed, e.g., for User1 of .NET Contacts , this is User2 and User3 in .NET Profile service1. The publisher also maintains information regarding the role of the subscribing user, e.g., in the context of User6 in .NET Profile service2, this is associate for User1, friend for User2).

In order for the publisher to keep this information current, the subscriber notifies the publisher whenever one of its users wants to unsubscribe or add a new subscription. For example, consider that User1 wants to add User4 into his live contact list, and remove User6. SSCP provides for transmission of subscription updates from subscriber to publisher using the same robust mechanism as are used for transmitting data changes.

The SSCP data pipe is robust and as such, is tolerant of transient network and/or service failures. At a fundamental level, to provide robustness, the publisher or subscriber needs to know that their transmitted messages have reached the destination, which means that each request from a sender should have a response from the receiver. If the message fails to reach the receiver, e.g. due to transient network and/or service failure, it is resent during the next update interval. This resend process is repeated until a response is received, with a specified number of such retries performed, after which no further attempts are made for an appropriately longer time to prevent a flood of retry messages, e.g., in the case of a catastrophic failure at the destination.

More subtle types of failures also need to be handled. For example, consider a publisher sending a request to the subscriber, informing it of the change in a stored profile. The subscriber ordinarily receives and processes the request, and sends a response to the publisher. However, if the network connection between the subscriber and the publisher has a transient failure and the response fails to reach the publisher, the publisher will re-send its request it request during the next update interval. In SSCP, the subscriber recognizes that this is a redundant request, and that it has already been processed, whereby the subscriber acknowledges the request again, but does not process it. In other words, a request is processed only once even if it is sent multiple times. Alternatively, a subscriber can process a repeat request any number of times, however the result of any subsequent processing should not change the first processing result. This property is referred to as idempotency.

For efficiency, because a typical service manages enormous amounts of data, partitioned over millions of users and the source data will be almost constantly changing, the protocol batches multiple requests and send them periodically. To this end, a protocol handler at the service periodically wakes up after a specified interval and sends the batched messages. Moreover, if a catastrophic failure (such as loss of power) occurs, this state data regarding the messages to send should not be lost, so data pertaining to protocol state should be stored in a durable manner, e.g., persisted to a hard disk.

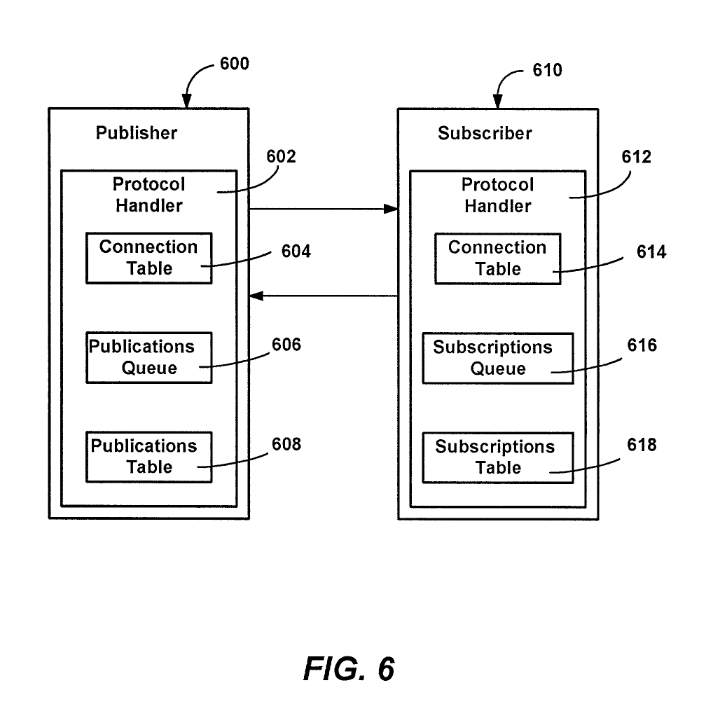

As generally represented in FIG. 6, SSCP is implemented at a publisher (service) 600 and subscriber (service) 610 by respective protocol handlers 602, 612, such as daemon processes or the like running with respect to a service. The publisher 600 and subscriber 610 exchange messages, and use this as a mechanism to communicate changes.

The requirements of the protocol dictate that SSCP handlers 602, 612 maintain several pieces of data, the sum total of which represents the state of a publisher or subscriber. As conceptually represented in FIG. 6, this data can be viewed as being segmented over several data structures 604-618. Note however that the arrangements, formats and other description presented herein are only logically represent the schema; the actual storage format is not prescribed, and an implementation may store in any fashion it deems fit as long as it logically conforms to this schema.

A publisher 600 communicates with a subscriber 610 using request and response messages. For example, when data changes at the publisher 600, the publisher 600, sends a request message to the subscriber 610 informing the subscriber that data has changed, normally along with the new data. The subscriber 610 receives the message, makes the required updates, and sends back an ACK message acknowledging that the message was received and that the changes were made. A subscriber 610 can also send a request message, such as when the subscriber 610 wants to subscribe or un-subscribe to a piece of datum. When the publisher 600 receives this message, the publisher 600 updates its list of subscriptions (in a publications table 608) and sends back a response acknowledging the request. Note that SSCP is agnostic to whether a response message for a given request is synchronous or asynchronous.

Thus, there are two primary parts to SSCP, a first from the publisher to the subscriber, which deals with sending changes made to the publisher's data, and a second from subscriber to the publisher, which deals with keeping the list of subscriptions synchronized. Furthermore, every service is required to provide notification to all other services that have subscriptions with it, or services with which it has subscriptions, when it is going offline or online.

The table below summarizes request messages, each of which having a corresponding response (e.g., ACK) message.

TABLE 1
REQUEST MESSAGES

| Message | Description | Type | From/To |
|---|---|---|---|
| UpdateSubscriptionData | Used by the publisher to publish | Request | Publisher |
| | changes to its data | | to Subscriber |
| updateSubscriptionDataResponse | Used by the subscriber to ACK | Response | Subscriber |
| | updateSubscriptionData | | to Publisher |
| UpdateSubscriptionMap | Used by the subscriber to inform | Request | Subscriber |
| | the publisher that subscriptions | | to Publisher |
| | have been added or deleted | | |
| UpdateSubscriptionMapResponse | Used by the publisher to ACK | Response | Publisher |
| | updateSubscriptionMap | | to Subscriber |
| ServiceStatus | Used by both publisher and | Request | Both |
| | subscriber to inform that they | | directions |
| | are going offline, or have come | | |
| | online | | |
| Standard .NET My Services ack | Used by both publisher and | Response | Both |
| | subscriber to ACK serviceStatus | | directions |
| | request | | |

Protocol parameters are supported by both the publisher and the subscriber and control the behavior of the protocol.

As noted above, SSCP supports the ability to batch request messages. Whenever there is a need to send a request message, such as when there are changes in publisher data or subscriptions, the service puts the corresponding request message into a publisher message queue 606. Periodically, the protocol handler 602 in the publishing service 600 wakes up and processes the messages in the queue 606. This period is called as the UpdateInterval, and is a configurable parameter.

To satisfy the robustness requirement, the publisher's protocol handler 602 needs to periodically resend requests until the publisher service 600 receives an acknowledge message (ACK). If the ACK for a message is successfully received, this message is purged from the queue 606. Until then, the message remains in the queue, flagged as having been sent at least once, so it will be retried at the next update interval. The number of times the publisher the publisher service 600 retries sending a message to the subscriber service 610 is configurable by the parameter RetryCount, i.e., after retrying this many times, the publisher service 600 assumes that the subscriber service 610 is dead. Then, once the maximum number of retries is over, the publisher service 600 waits for a relatively longer time. Once this longer time is elapsed, the publisher service 600 sets the RetryCount parameter to zero and begins resending the queued up requests over again. This longer time (before beginning the retry cycle), is configurable by the parameter ResetInterval.

Below is the summary of these protocol parameters:

TABLE 1
PROTOCOL PARAMETERS

| Parameter | Use |
|---|---|
| UpdateInterval | The interval after which the protocol handler wakes |
| | up and processes batched requests. |
| RetryCount | The number of times we retry a connection before |
| | assuming the remote service is dead. |
| ResetInterval | The interval after which a service marked as dead |
| | is retested for aliveness. |

Thus, to implement SSCP, the protocol handlers 602, 610 at the publisher and subscriber, respectively, track of several pieces of information, such as in their respective tables 604-618.

As with .NET in general, SSCP relies on the entities (services and users) being uniquely identifiable by the use of identifiers, e.g., every user in .NET has a unique identifier assigned by the Microsoft® Passport service. Each service, be it acting as a publisher or subscriber, also has a unique identifier, and in practice, a service ID will be a certificate issued by a certification authority.

Since there are various different kinds of identifiers, the following naming conventions are used herein:

SID Generic Service Identifier

PSID Publishing Service Identifier

SSID Subscribing Service Identifier

PUID Publishing User Identifier (PUID of myPublishingService user)

SUID Subscribing User Identifier (PUID of mySubscribingService user)

To send a request or a response, the service needs to know where the target is located, and, to ensure proper handling of the number of retries for a particular service, the handler needs to keep track of how many retries have been done. As mentioned above, this information is kept in the connections table, e.g., the connections table 604 for the publishing service 600 and the connections table 614 for the subscribing service 610. The following sets forth the information included in a connections table:

| | | | |
|---|---|---|---|
| SID | TO | CLUSTER | RETRY |

wherein “SID” comprises the service ID of a Subscriber or Publisher, “TO” comprises the URL at which the service is expecting requests comprises, “CLUSTER” comprises the cluster number of this service and “RETRY” comprises the current retry number of the service. There is one entry in this table for every target service. For a publisher 600, this means for each service that has one or more subscriptions registered with it; for a subscriber, this means every publisher that it has one ore more subscriptions with. When RetryCount<RETRY<Resetlnterval, the target service is assumed to be dead. Note that when an unknown service is recognized (i.e., one that is not present in the connections table), an attempt is made to contact immediately, without waiting until the next interval.

As also represented in FIG. 6, a publications table 608 is used by the publisher 600 to track the users across the services that have subscriptions with it. The publications table 608 includes records with the following fields:

| | | | | |
|---|---|---|---|---|
| PUID | SUID | SSID | ROLE | CN |

wherein PUID comprises the identifier of the publishing user, SUID comprises the identifier of the subscribing user, SSID comprises the identifier of the subscribing service, ROLE comprises the role assign to this SUID and CN comprises the last known change number of the publisher's data which was delivered to the subscriber (for updating deltas). There is one row (record) in the publications table 608 for each subscribing user/publishing user/subscribing service combination. The CN field is required to ensure recovery from certain catastrophic failures, as described below. The publications table 608 may be made visible at the schema level, but ordinarily should be read-only.

In general, given a publishing service P and a subscribing service S, there will exist a [possibly empty] set SM={(PUi, SUi), for i=1 to n} such that PUi is a user managed by P, SUi is a user managed by S, and SUi subscribes to PUi's data. The set SM is referred to as the subscription map of P with respect to S. The subscription map is obtained by the following query:

SELECT PUID, SUID FROM PUBLICATIONS WHERE SSID=S

As further represented in FIG. 6, the publisher 600 includes a publications queue table 606 that is used by the publisher for batching requests until the protocol handler 602 sends the requests when the UpdateInterval time is achieved. The publisher also retries requests for which a response has not been received, and thus tracks messages that need to be sent for the first time, or need to be resent, in the publications queue table 606.

An entry in the table 606 looks like this:

| | | |
|---|---|---|
| SUID | PUID | SSID |

wherein SUID comprises the identifier of the subscribing user, PUID comprises the identifier of the publishing user, and SSID comprises the identifier of the subscribing service. Note that for practical reasons, the publication queue 606 does not store messages, because a publisher services millions of users, whereby at any given instant, the publications queue 606 is likely have thousands of entries, and thus the amount of change data may be enormous. Thus, rather than storing the change data for each message in the table 608, the publisher 600 uses the entries in the queue table 606 to look up the ROLE of the SUID (from the publications table 608), and dynamically generates the request message during an update interval.

Turning to the subscriber service 610, a subscriptions table 618 is used by the subscriber 610 to track of its subscriptions that are in effect. An entry in the table 618 looks like this:

| | | | |
|---|---|---|---|
| SUID | PUID | PSID | CN |

wherein SUID comprises the identifier of the subscribing user, PUID comprises the identifier of the publishing user, PSID comprises the identifier of the publishing service, and CN comprises the last known change number received from the publisher. Note that the existence of a row in this table implies that the associated publishing service 600 has one or more associated entries in its publications table 608. The CN field is required to ensure that publisher retries are idempotent.

When a subscription is added, the subscribing user specifies the PUID of the user whose data he or she wants to subscribe to. For example, if a user1 changes a telephone number in user1's profile, user2 can subscribe to see the change in user2's contacts, whereby (if user2 is properly authorized) the profile service becomes a publisher of user1's changes and the contacts service becomes of subscriber of user1's changes. The subscriber queries .NET Services (myServices) to find out the ID of the publisher (PSID) and stores the SUID/PUID/PSID in subscriptions table 618.

A subscriptions queue table 616 is used by the subscriber 610 to batch its requests for sending by the protocol handler 610 whenever the UpdateInterval timer goes off. Also, the subscriber is required to retry requests for which a response has not been received, and thus keeps track of messages that need to be sent for the first time, or need to be resent, which is also done in the subscriptions queue table 616. An entry in the table looks like this:

| | | | | |
|---|---|---|---|---|
| SUID | PUID | PSID | OPERATION | GENERATION |

wherein SUID comprises the identifier of the subscribing user, PUID comprises the identifier of the publishing user, PSID the comprises the identifier of the publishing service, OPERATION comprises the Boolean (TRUE is an addition of a subscription and FALSE is a deletion of a subscription) and GENERATION indicates whether this message is fresh or has been sent one or more times already. In one implementation, the subscription queue 616 does not store the messages, but rather during an update interval, the protocol handler simply looks at the OPERATION field (which indicates whether this request is to add a subscription or delete a subscription) and dynamically generates the appropriate request message.

As an example of the use of GENERATION, consider a user adding a subscription, but deciding to delete it before the publisher has responded to the original add request. If the addition and deletion happened within the same update interval, that is, the add request has not been sent to the publisher yet, the row can simply be deleted from the queue 616. However, if the addition happened during a previous update interval, the add request was sent to the publisher, but an ACK was not received. In this case, the row cannot simply be deleted from the queue, as the publisher may have already received the add request and updated its subscription map. Thus, a delete request needs to be sent. To send a delete request, the OPERATION bit is changed from TRUE to FALSE. Then, when the subscriber sends the message again during the next update interval, the publisher simply deletes an added subscription. Note that if the publisher did not receive the original add or delete requests, it is equivalent to asking it to add an existing row or delete a non-existent row, which is handled by the idempotency rules.

As set forth in TABLE 1 above, SSCP defines several messages and the responses thereof.

The updateSubscriptionData message is used when a user's document gets modified, to send change information to the subscribers. When a document is modified, the publishing service 600 checks the contents of the publications table 608 for interested subscribers by issuing the following logical query:

SELECT * FROM PUBLICATIONS WHERE PUID=%AFFECTED_PUID% GROUP BY SSID, ROLE

The publisher 600 uses the resultant information to create an entry in the queue; the said entry records the information necessary to construct an updateSubscriptionData message to each affected subscribing service. At the next update interval, for the set of distinct ROLES used within the publication queue entries, an associated set of filtered data is created in a service- dependent manner. The data is then factored by SSID, and an updateSubscriptionData message is created for each affected subscriber and sent. arrives. The message format for updateSubscriptionData follows the following schema using the XMI conventions:

<updateSubscriptionData topic=“###”>1..1

| | |
|---|---|
| <updateData | publisher=“...” |

changeNumber=“###”>0..unbounded

<subscriber>0..unbounded</subscriber>
<subscriptionData>1..1</subscriptionData>

</updateData>

</updateSubscriptionData>

The data contained in the subscriptionData entity is defined by the participants in the service-to-service communication. Services which engage in multiple service-to-service communications should use the @topic attribute to disambiguate the meaning of the content. The @topic attribute is a URI and is specific to the instance of service-to-service communication. For instance the .NET Profile to .NET Contacts communication could use a URI such as “urn:microsoft.com:profile-contacts:1.0.” No service should attempt to accept an updateSubscriptionMap request for any conversation that they have not been explicitly configured to accept.

The format of the response message, updateSubscriptionDataResponse, follows the following schema using the XMI conventions:

<updateSubscriptionDataResponse topic=“###”>1..1

<updatedData publisher=“...”>0..unbounded

<subscriber>0..unbounded</subscriber>

</updatedData>
<deleteFromSubscriptionMap subscriber=“...”/>0..unbounded

</updateSubscriptionDataResponse>

The function of <updatedData> is to inform the publisher, while the <deleteFromSubscriptionMap> is used by the subscriber to tell the publisher that this SUID has been deleted, as described below. Note that if a response is received for data that is not subscribed, an immediate delete may handle such a response.

The updateSubscriptionMap message is used when a set of one or more users changes their subscription status(es). When this occurs, the set of changes are sent to the affected publishers within an updateSubscriptionMap message. When the publisher receives this message it updates the records in the publications table 608. It is not an error to add an entry more than once, nor to delete a non-existent entry. In both these cases the response is formatted so that success is indicated. This is required to ensure that retries are idempotent.

The request message format for updateSubscriptionMap follows the following schema using the XMI conventions:

<updateSubscriptionMap topic=“###”>1..1

<addToSubscriptionMap subscriber=“...”>0..unbounded

<publisher>0..unbounded</publisher>

</addToSubscriptionMap>
<deleteFromSubscriptionMap subscriber=“..”>0..unbounded

<publisher>0..unbounded</publisher>

</deleteFromSubscriptionMap>

</updateSubscriptionMap>

The addToSubscriptionMap section is used to make additions to the subscriptionMap, while the deleteFromSubscriptionMap removes entries.

The response message for updateSubscriptionMapResponse is formatted according to the following schema using the XMI conventions:

<updateSubscriptionMapResponse topic=“###”>1..1

<addedToSubscriptionMap subscriber=“...”>0..unbounded

<publisher>0..unbounded</publisher>

</addedToSubscriptionMap>
<deletedFromSubscriptionMap subscriber=“...”>0..unbounded

<publisher>0..unbounded</publisher>

</deletedFromSubscriptionMap>
<unknownPID publisher=“...”/>0..unbounded

</updateSubscriptionMapResponse>

The <addedToSubscriptionMap> and <deletedFromSubscriptionMap> provide status information, while the entity <unknownPID> is used in situations where a publishing user is deleted.

Services also need to send out messages when they come on-line, e.g., to wake up other services which have stopped sending them messages. To this end, whenever a service is going offline or coming online, the service should send out the following message to its partner services stored in its connections table (604 if a publisher, 614 if a subscriber, although it is understood that a service may be both a publisher and a subscriber and thus access both tables at such a time time). The format of this message using the XMI conventions is:

<serviceStatus>1..1

<online/>0..1
<offline />0..1

</serviceStatus>

Only one of the online or offline entities should be sent in any given message.

There is no defined response format for this message, as the normal .NET My Services ACK or fault response supplies the information needed.

By way of explanation of the operation of SSCP, a protocol handler wakes up when the interval timer goes off, whereby the handler sends the queued up requests, or when a request is received from another service, whereby the handler performs the requested action and sends a response.

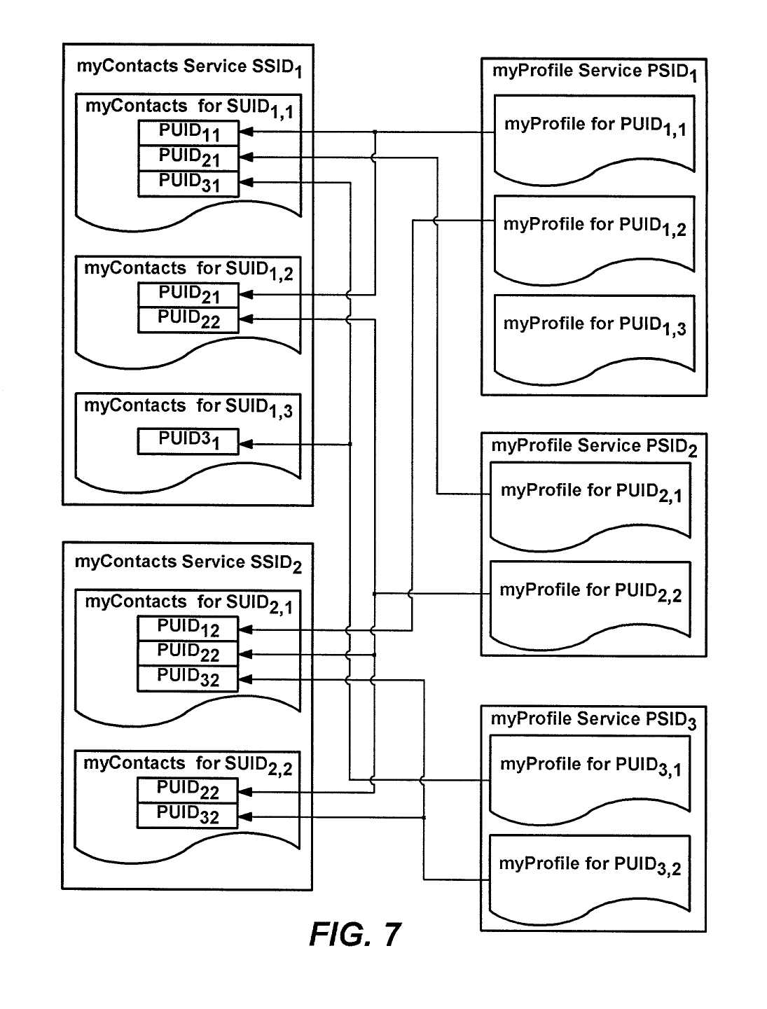

For purposes of this explanation of SSCP, a “Live Contacts” example, as generally discussed above, will be used herein. In the example, generally represented in FIG. 7, three NET Profile services, having IDs of PSID₁, PSID₂, and PSID₃, will be described. PSID₁ contains the profile documents of three users, namely PUID₁₁, PUID₁₂, and PUID₁₃; PSID₂ contains profile documents of two users: PUID₂₁ and PUID₂₂; and PSID₃ contains profile documents of two users: PUID₃₁ and PUID₃₂. There are two .NET Contacts services whose IDs are SSID1 and SSID2, wherein SSID1 manages contact documents of three users, SUID₁₁, SUID₁₂, and SUID₁₃, and SSID2 manages contact documents of two users SUID₂₁ and SUID₂₂.

Consider an initial subscription map, generally represented in FIG. 7, indicating with respect to PSID₁:

PUID₁₁: friend(SUID₁₁), associate(SUID₁₂)

PUID₁₂: other(SUID₂₁)

PUID₁₃:

with respect to PSID₂:

PUID₂₁: friend(SUID₁₁)

PUID₂₂: friend(SUID₂₁,SUID₂₂), associate(SUID₁₂)

and with respect to PSID₃:

PUID₃₁: associate(SUID₁₁), other(SUID₁₃)

PUID₃₂: friend(SUID₂₁), associate(SUID₂₂)

and also indicating with respect to SSID₁:

SUID₁₁: PUID₁₁, PUID₂₁, PUID₃₁

SUID₁₂: PUID₁₁, PUID₂₂

SUID₁₃: PUID₃₁

and with respect to SSID₂:

SUID₂₁: PUID₁₂, PUID₂₂, PUID₃₂

SUID₂₂: PUID₂₂, PUID₃₂

As described above, for the example data, the two contacts services each include a connections table. For SSID₁ this table (with included information such as cluster and URL omitted for simplicity) looks like:

SSID₁ CONNECTIONS Table

PSID₁
PSID₂
PSID₃

while for SSID₂ the connections table looks like:

SAID₂ CONNECTIONS Table

PSID₁
PSID₂
PSID₃

As described above, in addition, the three profile services each contain a publications table. For PSID₁ this table (with included information such as change number omitted for simplicity) looks like:

PSID₁ PUBLICATIONS Table

| | | | |
|---|---|---|---|
| PUID₁₁ | SUID₁₁ | SSID₁ | friend |
| PUID₁₁ | SUID₁₂ | SSID₁ | associate |
| PUID₁₂ | SUID₂₁ | SSID₂ | other |

which for PSID₂ looks like:

PSID₂ PUBLICATIONS Table

| | | | |
|---|---|---|---|
| PUID₂₁ | SUID₁₁ | SSID₁ | friend |
| PUID₂₂ | SUID₁₂ | SSID₁ | associate |
| PUID₂₂ | SUID₂₁ | SSID₂ | friend |
| PUID₂₂ | SUID₂₂ | SSID₂ | friend |

and for PSID₃ this looks like:

PSID₃ PUBLICATIONS Table

| | | | |
|---|---|---|---|
| PUID₃₁ | SUID₁₁ | SSID₁ | associate |
| PUID₃₁ | SUID₁₃ | SSID₁ | other |
| PUID₃₂ | SUID₂₁ | SSID₂ | friend |
| PUID₃₂ | SUID₂₂ | SSID₂ | associate |

If during an update interval on SSID₁, the user SUID₁₁ adds links to PUID₁₂ and PUID₃₂ and deletes the link from PUID₁₁, while SUID₁₂ deletes the link to PUID₁₁ the contents of the subscriptions queue for SSID₁ is:

SSID₁ SUBSCRIPTIONS_QUEUE

| | | | | |
|---|---|---|---|---|
| SUID₁₁ | PUID₁₂ | PSID₁ | TRUE | 0 |
| SUID₁₁ | PUID₃₂ | PSID₃ | TRUE | 0 |
| SUID₁₁ | PUID₁₁ | PSID₁ | FALSE | 0 |
| SUID₁₂ | PUID₁₁ | PSID₁ | FALSE | 0 |

When processed, this table will generate two different updateSubscriptionMap requests that are sent to the two affected .NET Profile services.

PSID₁ is sent:

<updateSubscriptionMap topic=“####”>

<addToSubscriptionMap subscriber=“SUID₁₁”>

<publisher>PUID₁₂</publisher>

</addToSubscriptionMap>
<deleteFromSubscriptionMap subscriber=“SUID₁₁”>

<publisher>PUID₁₁</publisher>

</deleteFromSubscriptionMap>
<deleteFromSubscriptionMap subscriber=“SUID₁₂”>

<publisher>PUID₁₁</publisher>

</deleteFromSUbscriptionMap>

</updateSubscriptionMap>

and PSID₃ is sent:

<updateSubscriptionMap topic=“####”>

<addToSubscriptionMap subscriber=“SUID₁₁”>

<publisher>PUID₃₂</publisher>

</addToSubscriptionMap>

</updateSubscriptionMap>

After receiving these messages, each .NET Profile service updates the contents of their publications table as follows (with the CN change number column omitted).

For PSID₁, the resulting table looks like:

PSID₁ PUBLICATIONS Table

| | | | |
|---|---|---|---|
| PUID₁₂ | SUID₂₁ | SSID₂ | Other |
| PUID₁₂ | SUID₁₁ | SSID₁ | associate |

and for PSID₃, the resulting table looks like:

PSID₃ PUBLICATIONS Table

| | | | |
|---|---|---|---|
| PUID₃₁ | SUID₁₁ | SSID₁ | associate |
| PUID₃₁ | SUID₁₃ | SSID₁ | Other |
| PUID₃₂ | SUID₁₁ | SSID₁ | Other |
| PUID₃₂ | SUID₂₁ | SSID₂ | Friend |
| PUID₃₂ | SUID₂₂ | SSID₂ | associate |

Based on the original configuration, PUID₁₁ changes the contents on its profile, whereby PSID₁ constructs the following updateSubscriptionData message to SSID₁:

<updateSubscriptionData topic=“####”>

<updateData publisher=“PUID₁₁” changeNumber=“###”>

<subscriber>SUID₁₁</subscriber>
<subscriptionDatafriend-info</subscriptionData>

</updateData>
<updateData publisher=“PUID₁₁” changeNumber=“###”>

<subscriber>SUID₁₂</subscriber>
<subscriptionData>associate-info</subscriptionData>

</updateData>

</updateSubscriptionData>

Note that the message is split between two updateData blocks because of different roles being assigned. If PUID₂₂ were to change their profile information this would result in PSID₂ sending out two updateSubscriptionData messages to SSID₁ and SSID₂. The message to SSID₁:

<updateSubscriptionData topic=“####”>

<updateData publisher=“PUID₂₂” changeNumber=“###”>

<subscriber>SUID₁₂</subscriber>
<profileData>associate-information</profileData>

</updateData>

</updateSubscriptionData>

The message to SSID₂:

<updateSubscriptionData topic=“####”>

<updateData publisher=“PUID₂₂” changeNumber=“###”>

<subscriber>SUID₂₁</subscriber>
<subscriber>SUID₂₂</subscriber>
<profileData>friend-information</profileData>

</updateData>

</updateSubscriptionData>

Note in this case, the message to SSID₂ only contains one copy of the data optimizing for identical roles.

Thus, as demonstrated above, and in accordance with one aspect of the present invention, the amount of information that is transmitted from one service to another is significantly reduced in SSCP because the change information for one user at a publisher service that is subscribed to by multiple users at a subscriber service who are assigned the same role at the publishing service, are aggregated into a single message. In other words, the publisher operates in a fan-in model to put change information together based on their roles, rather than separate it per user recipient, and leaves it up to the subscriber to fan the information out to the appropriate users. By way of example, a user may change his profile to reflect a new telephone number, address, occupation and so forth;, , based on what they are authorized to see, e.g., as friends (who can see all such changes) or associates (who can only see telephone number and occupation changes), SSCP constructs a message with one copy of the friends data and one copy of the associates data, and sends this message to the subscriber. The implicit assumption in this description is that all the subscribers reside on the same service. Should any of the subscribers reside on a different service, a separate message will be sent to that service, following the same aggregation principles outlined above.

SSCP is a robust protocol which is able to handle many different kinds of failure scenarios, including when the publisher fails, the subscriber fails, the link between publisher and subscriber goes down before the subscriber can respond (after it has received a request), the link between publisher and subscriber goes down before the publisher can respond (after it has received a request), the publisher loses the subscription map, and the subscriber loses published data. In general, these failure scenarios are handled by message retries and idempotency, as generally described below.

Message retries will be described with respect to an example that assumes the publisher sends the request message. However the message-retry mechanism applies equally well when the subscriber sends the retry message. When the publisher sends a request message, the publisher sends the message from the publications queue and waits for a response to this message. If the publisher gets a response, it deletes the message from the queue, otherwise it keeps the message in the queue and resends it the next time Update Interval timer goes off. As described above the number of retries occurs a specified maximum number of times, after which the subscriber is considered dead. After some longer interval time, the subscriber is automatically tested for aliveness, and the process begins all over. This aliveness testing can also be limited to some number of times. This method ensures that an alive subscriber does not miss an updateSubscriptionData message.

As described above, retry attempts should idempotent—that is, multiple retries of a request should behave as if the request had been sent only once. Idempotency is achieved by keeping track of the change number, or CN, which is a column in the publications and subscriptions tables as described above. Note that the underlying service implementation has change number data and keep track of it, entirely independent of SSCP. As used herein, change numbers are represented as an as an integer sequence, although it is understood that change numbers need not be sequential, but may be whatever the service has, as long as it increases (or decreases) monotonically. Note also that the smallest unit of change is a .NET blue node, the smallest query-able, cacheable, unit of data in .NET.

In general, when a fresh subscription is created, the publisher 600 adds a row into the publications table 608 (FIG. 6), with CN being set to the lower (upper) bound for the change number. . Note that since every .NET blue node already has a change number associated with it, this value is guaranteed to be available. The subscriber 610 also keeps track of the value of this CN in its subscriptions table 618. Whenever the publisher 600 sends an updateSubscriptionData request to the subscriber, it includes the value of CN that it currently has for this [.NET blue]node. It records this CN in the publications table 608.

On receiving the updateSubscriptionData message, the subscriber 610 updates its copy of the CN (present in the CN field of subscriptions table 618) to the new value. If, due to a transient network failure, the publisher 600 fails to receive the response message from the subscriber, the publisher resends the request message again at the next update interval. On receiving this request, the subscriber inspects the CN, and determines that it has already processed this message because the CN in the message is the same as the CN that it has. The subscriber treats this as a no-op with respect to making any update, and sends back a response whereby the publisher will normally receive it and delete this message from the message queue. The net result is that any message received multiple times by the subscriber is processed exactly once, i.e., retries are idempotent.

The subscriber achieves idempotency because when a publisher receives a request to add a preexisting entry to its subscription map, it should treat this as a no-op, and not return an error. When the publisher receives a request to delete a non-existent entry from its subscription map, it should treat this as a no-op and not return an error. As can be readily appreciated, multiple add or delete from subscription map requests behave as if there was only one such request.

If the publisher fails, the publisher will not be able to respond to subscriber requests to update the subscription map. This is handled by resending the message until a response is received. As with other retries, long-term or catastrophic failures are handled by having a limit on the number of retries and waiting for a longer time before starting all over, and then if still no response after some number of “longer” time cycles, requiring the attempted recipient to initiate contact.

If down, the publisher will also not receive any responses that the subscriber may have sent to its updateSubscriptionData requests. From the point of view of the subscriber, this is logically indistinguishable from the case where the link between subscriber and publisher fails, and is handled as described below.

Subscriber failures are very similar to what happens when the publisher fails. The subscriber continues to resend the updateSubscriptionMap requests until it receives a response from the publisher, or the retry limit is reached, whereupon the retry attempts will be held off for a longer delay time. As in the publisher case, the non-reception of responses by the subscriber is the same as a link failure, the handling of which is explained below.

In the case where the link between the publisher and subscriber fails, the subscriber has sent an updateSubscriptionMap message, the publisher has processed this message and sent a response, but the subscriber does not receive the response. As described above, this causes the subscriber to resend the message. Thus the publisher receives a duplicate updateSubscriptionMap message from the subscriber, detected via the change number. Since retries are idempotent, the publisher simply sends back a response to the subscriber. A subscriber to publisher link failure is handled similarly.

Occasionally, a PUID may be deleted from the publisher and for some reason the subscriber does not get notified of this event. When a subscriber sends an updateSubscriptionMap request concerning a PUID that no longer exists in the publisher, the publisher comes back with the <unknownPID> entity in the response. This tells the subscriber to update its image of the subscription map.

Similarly, a SUID may be occasionally deleted at the subscriber and in general, the publisher has no way of knowing it. On data change, the publisher sends an update request to the deleted SUID, and when this happens, the subscriber sends a <deleteFromSubscriptionMap> entity in its response to notify the publisher of the SUID deletion. This tells the publisher to update its subscription map.

One catastrophic form of failure is when a publisher loses its subscription map or the subscriber loses its subscription data. This can cause various levels of data loss. For example, if the publisher has experienced a catastrophic failure, such as disk crash, the publisher needs to revert to data from a back up medium such as tape. As a result, its subscription map is out of date. For the subscriber, a similar situation makes its subscribed data out of date.

In such an event, the service that experienced the loss sends a message requesting an update. The publisher's subscription map can be brought up to date by the information stored in subscriptions table in the subscriber, while a subscriber's data can be made up to date by the subscription map and the change number stored in the publications table.

The following section describes pseudocode for implementing key aspects of publisher and subscriber protocol handlers.

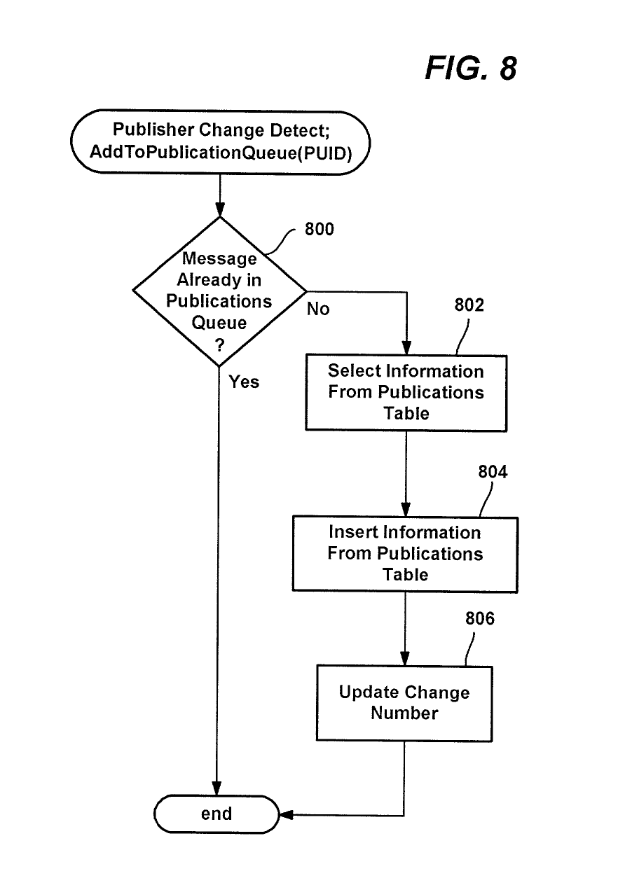

When the data changes occur in the publisher, actions implied by the following pseudo-code (as generally represented in FIG. 8) are taken:

OnRequestPub(SSID,requestMessage)
{

// what kind of a request message is this?
switch (requestType)
{
// request is for updating subscription map
case updateSubscriptionMap:

// the request can have multiple entities. Loop for each
for (each entity in request)
{

// See if the PUID of the <publisher> is known
if (LookUpUser(PUID))
{

// new subscription
if (entity ==“addToSubscriptionMap>”)
{

// determine role of the subscriber
role = FindRole(SUID);
// insert into PUBLICATIONS table. Note that
// CN is initialized to the current value that the
publisher
// has for it. Note also that
// trying to add an existing row is not an error
## IF NOT EXISTS
## (SELECT SUID
## FROM PUBLICATIONS
## WHERE
## SUID = %SUID% AND
## PUID = %PUID% AND
## SSID = %SSID%)
## INSERT INTO PUBLICATIONS VALUES
## (%PUID%, %SUID%, %SSID%,
%role%, %CN%)
// append to the response message
response += “<addedToSubscriptionMap>”;

} // addToSubscriptionMap
else if (entity == “<deletedFromSubscriptionMap>”)
{

// delete from PUBLICATIONS table. If a non-
existent
// row is asked to be deleted, the delete will
simply
// return without deleting anything
## DELETE PUBLICATIONS
## WHERE
## SUID = %SUID% AND
## PUID = %PUID% AND
## SSID = %SSID%
// append to the response message
response += “<deletedFromSubscriptionMap>”;

} // deleteFromSubscriptionMap

} // LookUpUser(PUID)
else
{

// append an “unknown PUID entity to response
response += “<unknownPUID>”;

}

}// for (each entity in request)
break; // updateSubscriptionMap

case serviceStatus:

// if serviceStatus is online
if (entity == “<online>”)
{

// reset retry count to zero
## UPDATE CONNECTIONS
## SET RETRY = 0
## WHERE SID = %SSID%

}
else if (entity == offline)
{

// resent retry count to maximum
## UPDATE CONNECTIONS
## SET RETRY = %RetryCount%
## WHERE SID = %SSID%

}
// append a standard .NET ack message
response += “<standard.NETck>”;
break; // serviceStatus

}// switch (requestType)
// Send response back service
Send(SSID, response);

}

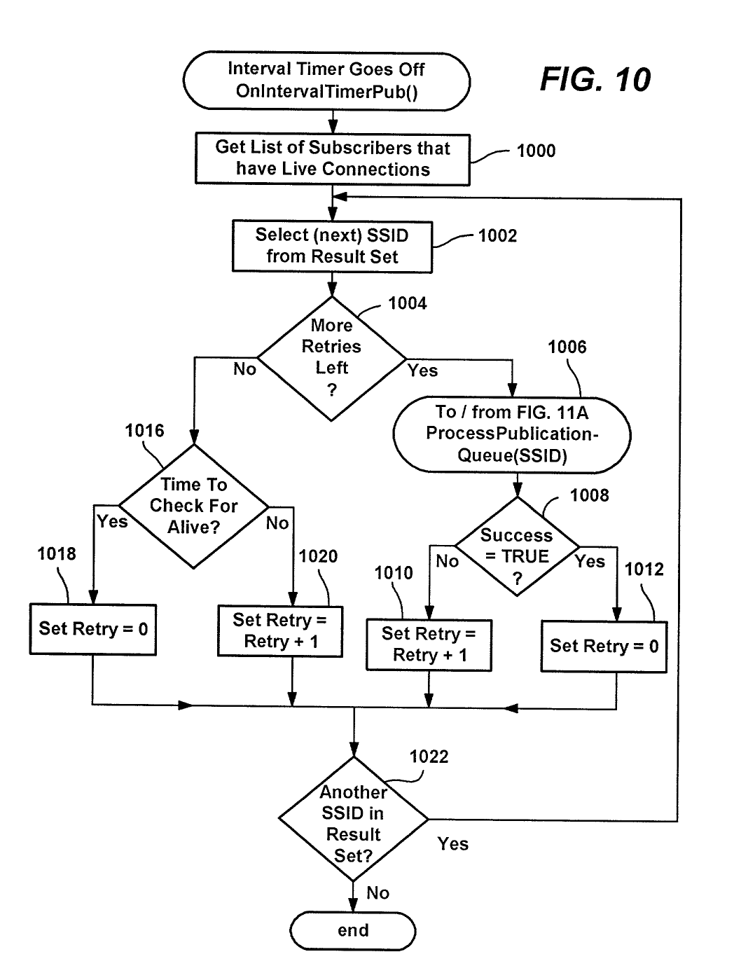

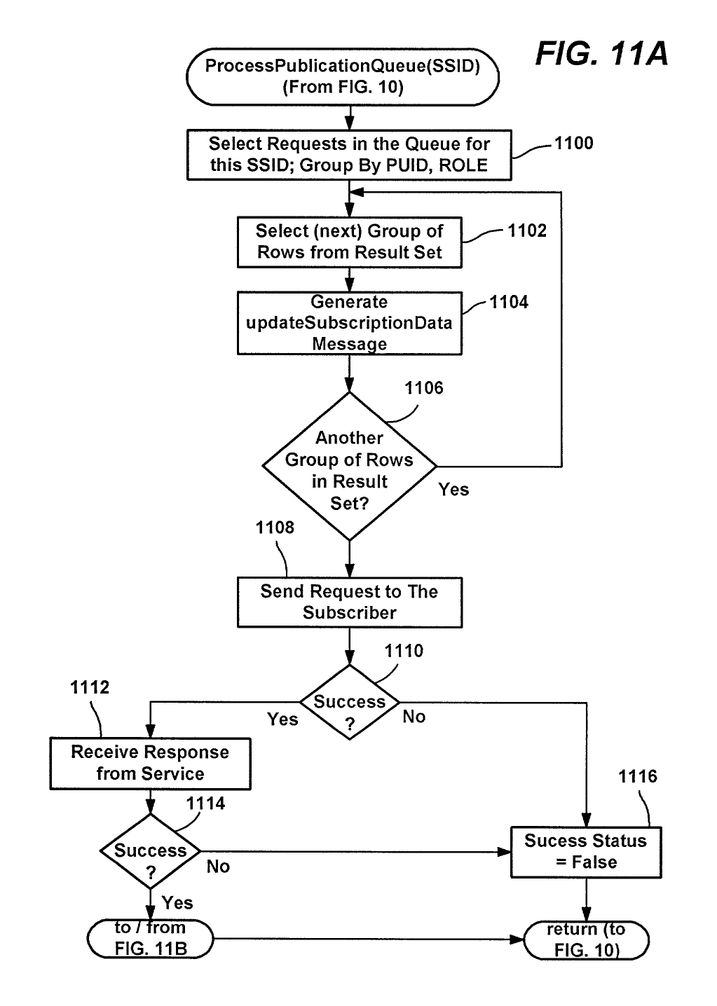

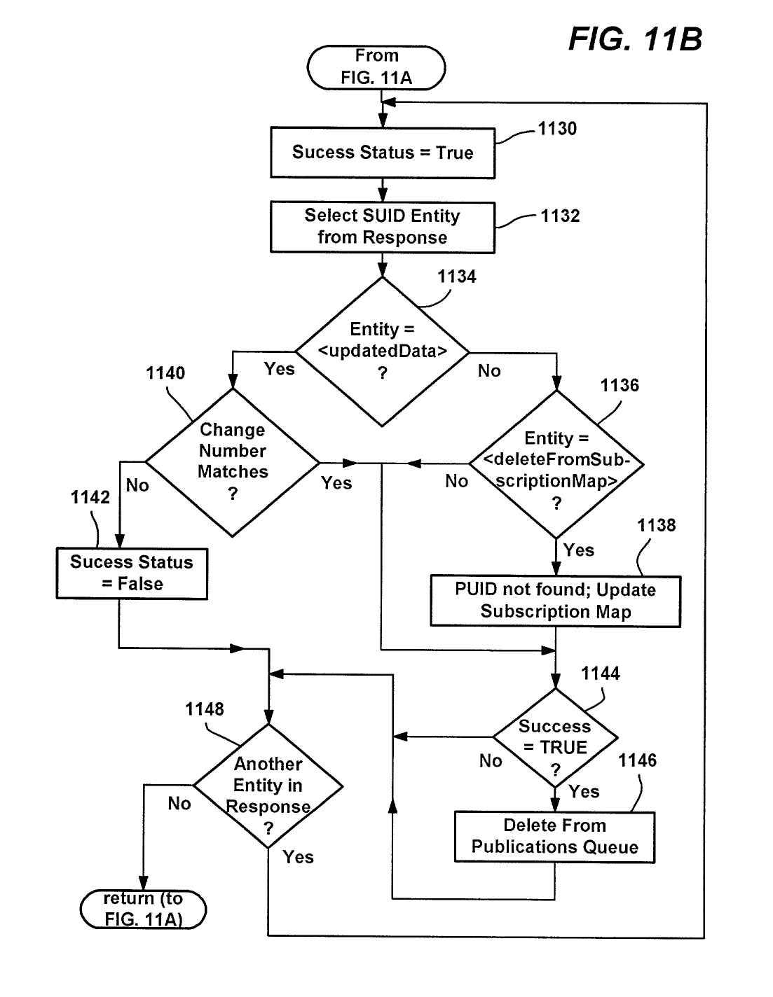

When the update interval timer goes off at the publisher, it takes actions implied by the following pseudo-code, as generally represented in FIGS. 10 and 11A-11B:

OnIntervalTimerPub( )
{

// get a list of all Subscribes that have live connections
## SELECT SID AS SSID, RETRY FROM CONNECTIONS
for (each SSID in result set)
{

if (RETRY < RetryCount)
{

// more retries left. process messages in the publication queue
// for this SSID
if (ProcessPublicationQueue(SSID))
{

// all requests in queue for this SSID have been sent, and
// responses have been received
## UPDATE CONNECTIONS
## SET RETRY = 0
## WHERE SID = %SSID%

}
else
{

// no response from SSID; increment retry counter
## UPDATE CONNECTIONS
## SET RETRY = RETRY + 1
## WHERE SID = %SSID%

}

} // retry < retryCount
else if (RETRY < ResetInterval)
{

// retry count exceeded; see if it's time to check for alive-ness
## UPDATE CONNECTIONS
## SET RETRY = RETRY + 1
## WHERE SID = %SSID%

} // retry < retryInterval
else
{

// check for alive-ness by starting another series of retries
## UPDATE CONNECTION
## SET RETRY = 0
## WHERE SID = %SSID%

}

} // for (each SSID in result set)

}
ProcessPublicationQueue(SSID)
{

// select requests in the queue for this SSID; group them by
// PUID followed by ROLE. The rows in each group will result
// in one updateSubscriptionData message
## SELECT * FROM PUBLICATIONS_QUEUE
## WHERE SSID = %SSID%
## GROUP BY PUID, ROLE
for (each group of rows in the result set)
{

// generate an updateSubscriptionData message
request += GenerateMessage(group);

}
// Send request to the subscriber
if(!Send(SSID, request)) return FALSE;
// Receive response from service
if(!Recv(SSID, response)) return FALSE;
// The response has one entity for each SUID
for (each entity in response)
{

success = true;
if (entity == “<updatedData>”)
{

// publisher needs to check the change number returned in the
// response message and verify if it matches; if it does, then
// everything is cool; if not, then the subscriber has sent a
// spurious response for a previous request, and so this
// message is ignored
## SELECT CN AS STORED_CN
## FROM PUBLICATIONS
## WHERE PUID = %publisher% AND SUID = %subscriber%
// CN is the change number contained in the response
if (STORED_CN != CN)

success == false;

}
if (entity == “<deleteFromSubscriptionMap>”)
{

// subscriber did not find PUID in its SUBSCRIPTIONS table
// publisher should update its subscription map
## DELETE FROM PUBLICATIONS
## WHERE PUID=%subscriber% AND SSID=%SSID%

}
// since request has received the proper response, it can be deleted from
// the publication queue
if (success == true)
{

## DELETE FROM PUBLICATIONS_QUEUE
## WHERE SSID = %SSID% AND PUID = %publisher% AND SUID = %subscriber%

}

}

}

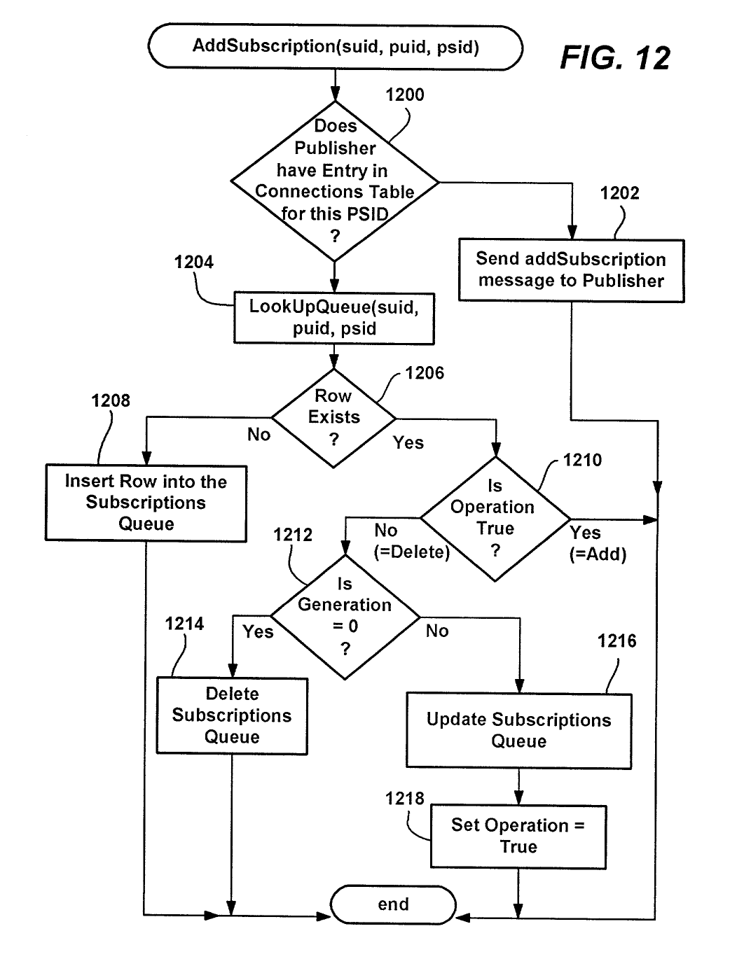

When a subscription is added, the actions implied by the following pseudo-code (also generally represented in FIG. 12) are taken:

AddSubscription(suid, puid, psid)
{

// check if the publisher has an entry in the CONNECTIONS
table for this
// PSID
if (UnknownServiceID( psid ))
{

// no entry exists; send an addSubscription message
immediately to
// the publisher.
UpdateSingleSubscriptionMap( suid, puid, psid );

}
else
{

// see if row exists in the subscriptions queue
if (LookUpQueue(suid, puid, psid)
{

// if a row exists in the subscription queue then:
// if OPERATION is TRUE (=add) then do nothing
// if it is FALSE (=delete) and GENERATION = 0, then
// delete the row; otherwise, change FALSE to TRUE
## SELECT OPERATION, GENERATION
## FROM SUBSCRIPTIONS_QUEUE
## WHERE SUID = %suid% AND PUID = %puid% AND
PSID = %psid%
if (OPERATION == FALSE)

if (GENERATION == 0)
{

## DELETE SUBSCRIPTIONS_QUEUE
## WHERE SUID = %suid% AND PUID =
%puid% AND PSID = %psid%

}
else
{

## UPDATE SUBSCRIPTIONS_QUEUE
## SET OPERATION = TRUE
## WHERE SUID = %suid% AND PUID =
%puid% AND PSID = %psid%

}

}
else
{

// row does not exist; insert into the queue
## INSERT INTO SUBSCRIPTION_QUEUE
## VALUES (%suid%, %puid%, %psid%, TRUE, 0)

}

}

}

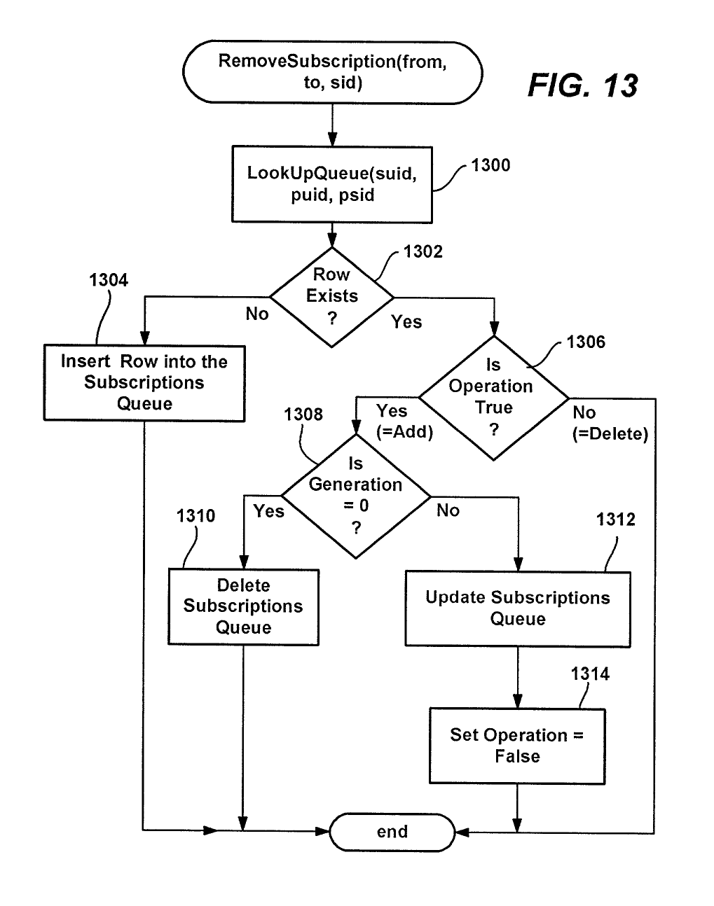

When a subscription is removed, the subscriber takes actions implied by the following pseudo-code, as generally represented in FIG. 13:

Remove Subscription(from, to, sid)
{

// see if row exists in the subscriptions queue
if (LookUpQueue(suid, puid, psid)
{

// if a row exists in the subscription queue then:
// if OPERATION is FALSE (=delete) then do nothing
// if it is TRUE (=add) and GENERATION = 0, then
// delete the row; otherwise, change TRUE to FALSE
## SELECT OPERATION, GENERATION
## FROM SUBSCRIPTIONS_QUEUE
## WHERE SUID = %suid% AND PUID = %puid% AND PSID = %psid%
if (OPERATION == TRUE)

if (GENERATION == 0)
{

## DELETE SUBSCRIPTIONS_QUEUE
## WHERE SUID = %suid% AND PUID = %puid% AND PSID = %psid%

}
else
{

## UPDATE SUBSCRIPTIONS_QUEUE
## SET OPERATION = FALSE
## WHERE SUID = %suid% AND PUID = %puid% AND PSID = %psid%

}

}
else
{

// row does not exist; insert into the queue
## INSERT INTO SUBSCRIPTION_QUEUE
## VALUES (%suid%, %puid%, %psid%, FALSE, 0)

}

}

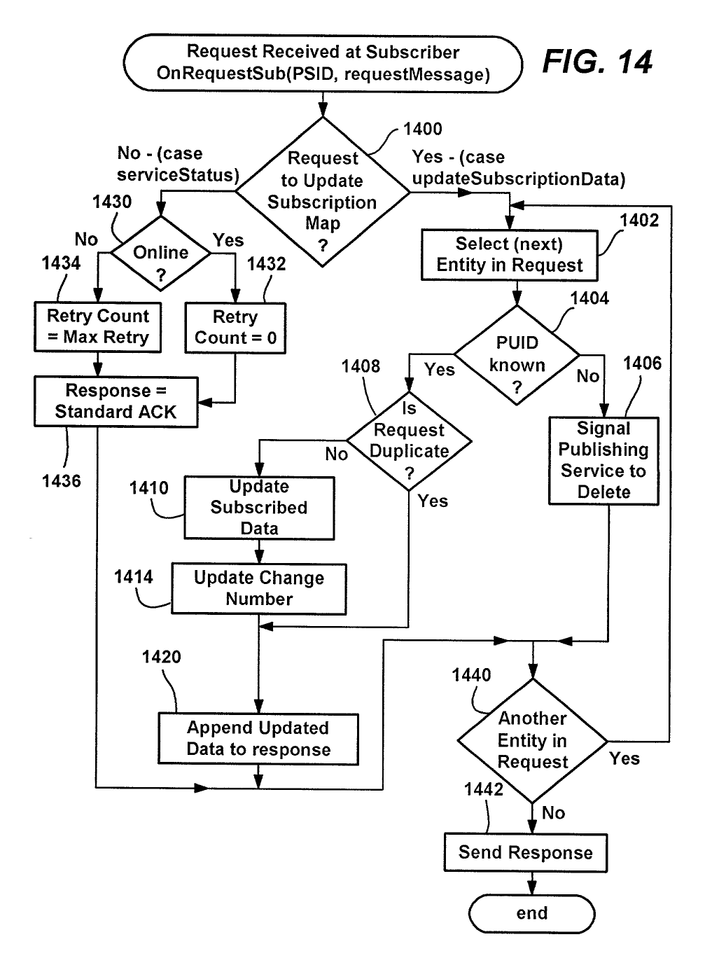

When a subscriber receives a request, the actions implied by the following pseudo-code are performed as generally represented in FIG. 14:

OnRequestSub(PSID, request)
{

// what kind of a request message is this?
switch (requestType)
{
// request is for updating subscription map
case updateSubscriptionData:

// request may contain multiple entities
for (each entity in request)
{

// check to see if the publisher's PUID is in the
SUBSCRIPTIONS table
if (LookUpPUID(publisher))
{

// is this a duplicate request message? I can find
this by looking
// at change numbers
## SELECT CN AS STORED_CN
## FROM SUBSCRIPTIONS
## WHERE PUID = %publisher% AND SUID =
%subscriber%
## AND PID = %pid%
// cn is the change number present in the message
if (cn !=STORED_CN)
{

// This function updates subscribed data
UpdateData(entity);
// update the change number
## UPDATE SUBSCRIPTIONS
## SET CN = cn
## WHERE PUID = %publisher% AND SUID =
%subscriber%
## AND PID = %pid%

}
// append to response
response += “<updatedData>”;

}
else
{

// publisher is unknown; signal publishing service
to delete it
response += “<deleteFromSubscriptionMap>”;

}

} // for
// send response to the publishing service
break; // updateSubscriptionData

case serviceStatus:

// if serviceStatus is online
if (entity == “<online>”)
{

// reset retry count to zero
# UPDATE CONNECTIONS
# SET RETRY = 0
# WHERE SID = %PSID%

}
else if (entity == offline)
{

// resent retry count to maximum
# UPDATE CONNECTIONS
# SET RETRY = %RetryCount%
# WHERE SID = %PSID%

}
// append a standard .NETack message
response += “<standard.NETAck>”;
break; // serviceStatus

} // switch (requestType)
// Send response back service
Send(PSID, response);

}

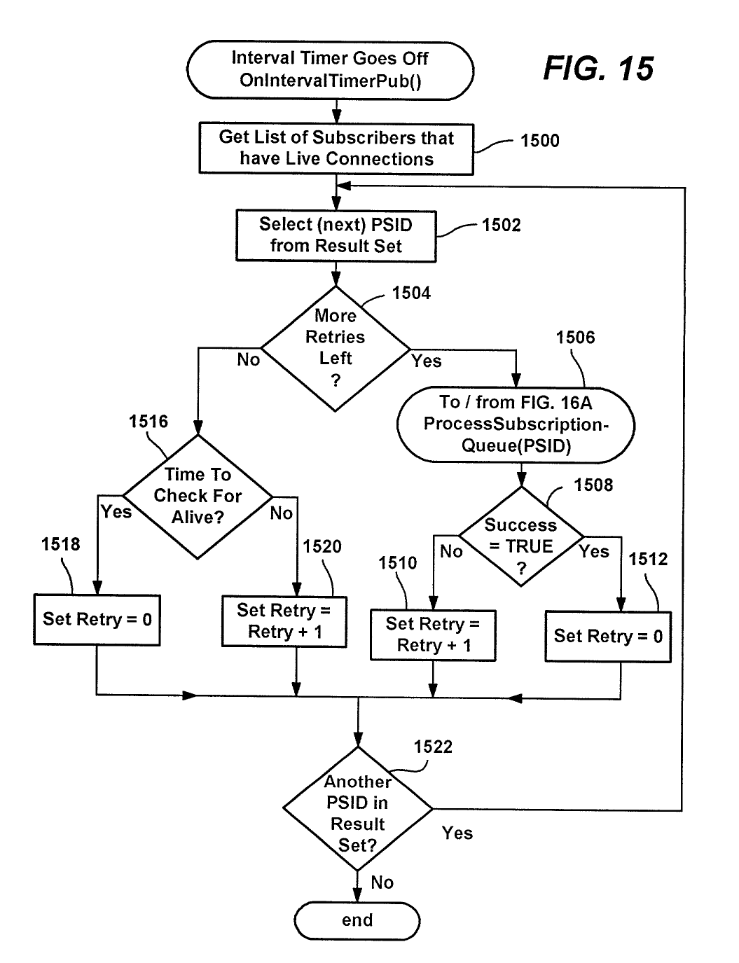

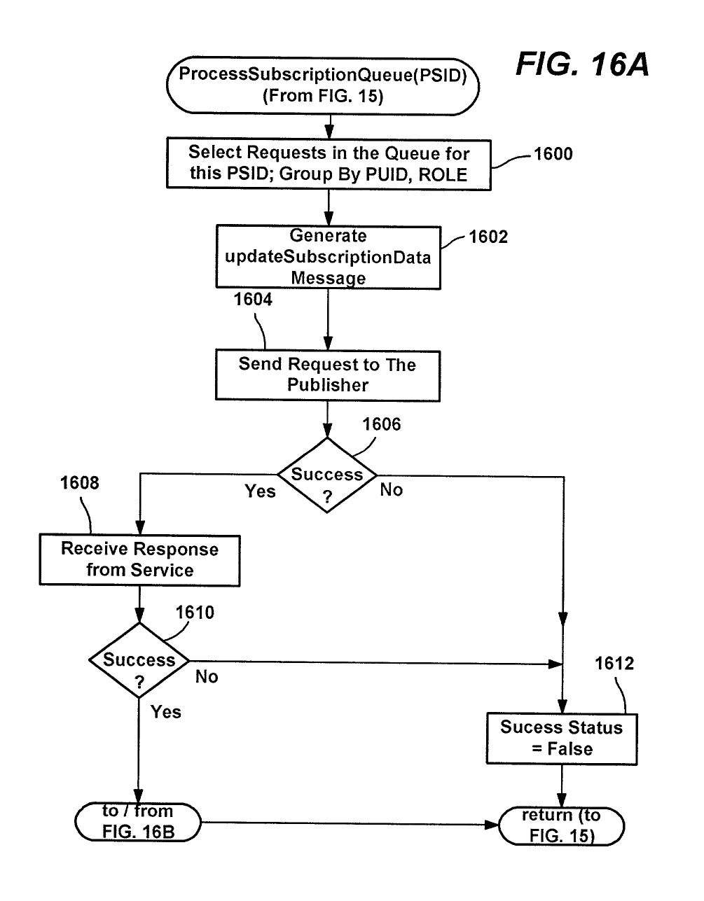

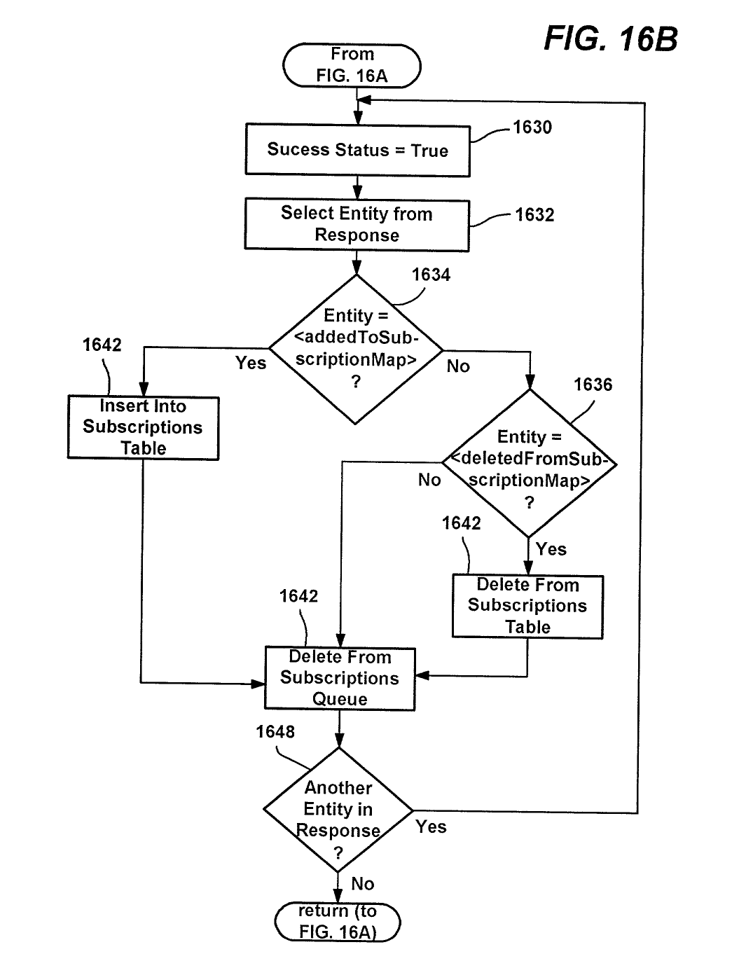

When the update interval timer goes off at the subscriber, it takes actions implied by the following pseudo-code as generally represented in FIGS. 15 and 16A-16B:

OnIntervalTimerSub( )
{

// get a list of all publishers that have live connections
## SELECT SID AS PSID, RETRY FROM CONNECTIONS
for (each PSID in result set)
{

if (RETRY < RetryCount)
{

// more retries left. process msgs in the publication
q for this SSID
if (ProcessSubscriptionQueue(PSID))
{

// all requests in queue for this PSID have been sent,
and
// responses have been received
## UPDATE CONNECTIONS
## SET RETRY = 0
## WHERE SD = %PSID%

}
else
{

// no response from PSID; increment retry counter
## UPDATE CONNECTIONS
## SET RETRY = RETRY + 1
## WHERE SID = %PSID%

}

} // retry < retryCount
else if (RETRY < ResetInterval)
{

// retry count exceeded; see if it's time to check for
alive-ness
## UPDATE CONNECTIONS
## SET RETRY = RETRY + 1
## WHERE SID = %PSID%

} // retry < retryInterval
else
{

// check for alive-ness by staffing another series of retries
## UPDATE CONNECTION
## SET RETRY = 0
## WHERE SID = %PSID%

}

} // for (each SSID in result set)

}

ProcessSubscriptionQueue(PSID)
{

// select requests in the queue for this PSID; group them by
// PUID followed by OPERATION. The rows in each group will result
// in one updateSubscriptionData message
## SELECT * FROM PUBLICATION_QUEUE
## WHERE PSID = %PSID%
// generate an updateSubscriptionMap message. Note that all requests
// for a given psid can be bunched into one single message. Thus, there
// no need to group by column and loop for each group
request += GenerateMessage( );
// Send request to the publisher
if(!Send(PSID, request)) return FALSE;
// Receive response from service
if(!Recv(PSID, response)) return FALSE;
// The response has one entity for each row in subscription queue
for (each entity in response)
{

if (entity == “<addedToSubscriptionMap>”)
{

// publisher successfully added its subscription map
// subscriber now adds to its subscriptions table
## INSERT INTO SUBSCRIPTIONS
## VALUES (%subscriber%, %publisher%, %psid%)

}
if (entity == “<deletedFromSubscriptionMap>”)
{

// publisher successfully deleted from its subscription map
// subscriber now deletes from its subscriptions table
## DELETE FROM SUBSCRIPTIONS
## WHERE SUID=%subscriber% AND PUID = %publisher% AND PSID = %PSID%

}
// since request has received the proper response, it can be deleted from
// the subscriptions queue
## DELETE FROM SUBSCRIPTIONS_QUEUE
## WHERE PSID = %PSID% AND PUID = %publisher% AND SUID = %subscriber%

}

}

SSCP Alternative

As described above, alternative ways to implement a service-to-service communications protocol are feasible. This section describes one such way, and also exemplifies an alternative wherein each user can have multiple instances of a .NET (or my*) service. For example, a user can have two instances of the myContacts service, one for company contacts and one for personal contacts, (although the same segmentation can also be achieved using categories). To distinguish between multiple instances of a user's services, there exists an identifier called INSTANCE, stored in the myServices service. For a given user and a given service, there also exists the notion of a default instance. The combination of an owner-id (OID) and INSTANCE is enough to uniquely identify a content document. Conceptually, a content document (determined by the OID/INSTANCE pair of the publisher) gets published to another content document (determined by the OID/INSTANCE pair of the subscriber), which are sometimes referred to herein as the publishing document and subscribing document, respectively.

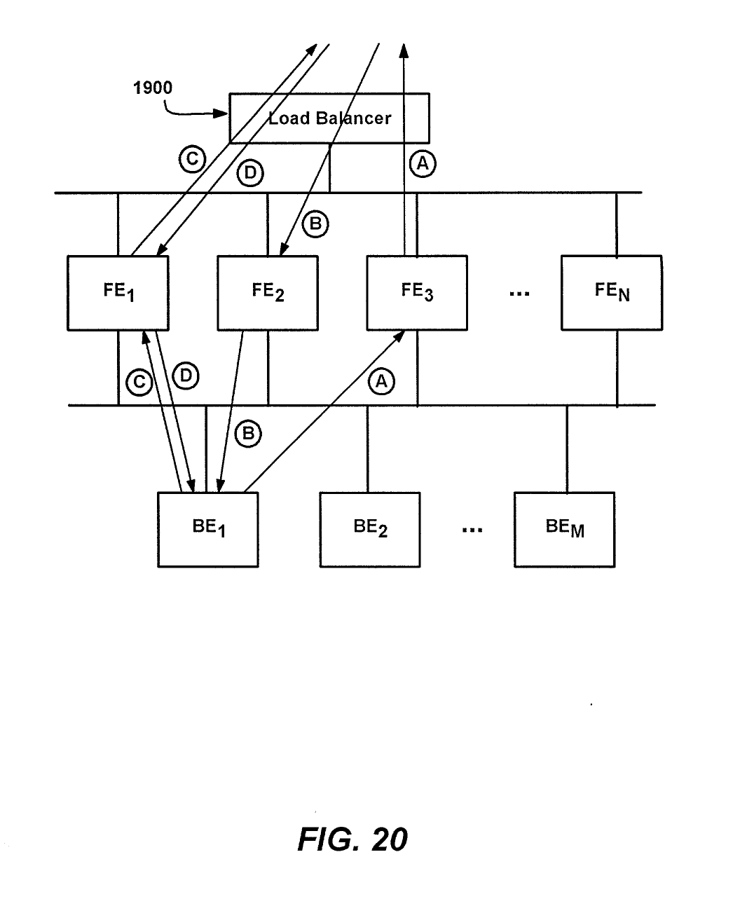

FIG. 20/17 shows an example of a publisher-subscriber relationship. In FIG. 20/17, there are two myProfile services 1701 and 1702, each managing the profiles of three users. User₁ has three instances (1704₁-1704₃) of a myProfile service, and user₆ has four instances, one of which resides in the first myProfile service 1701, three of which reside in the second myProfile service 1702. There is one myContacts service 1720, which manages the contact information of two users; user₂ has two instances (1722₁ and 1722₂) of the service. In the real world, each of these services will manage the data for millions or even hundreds of millions of users.

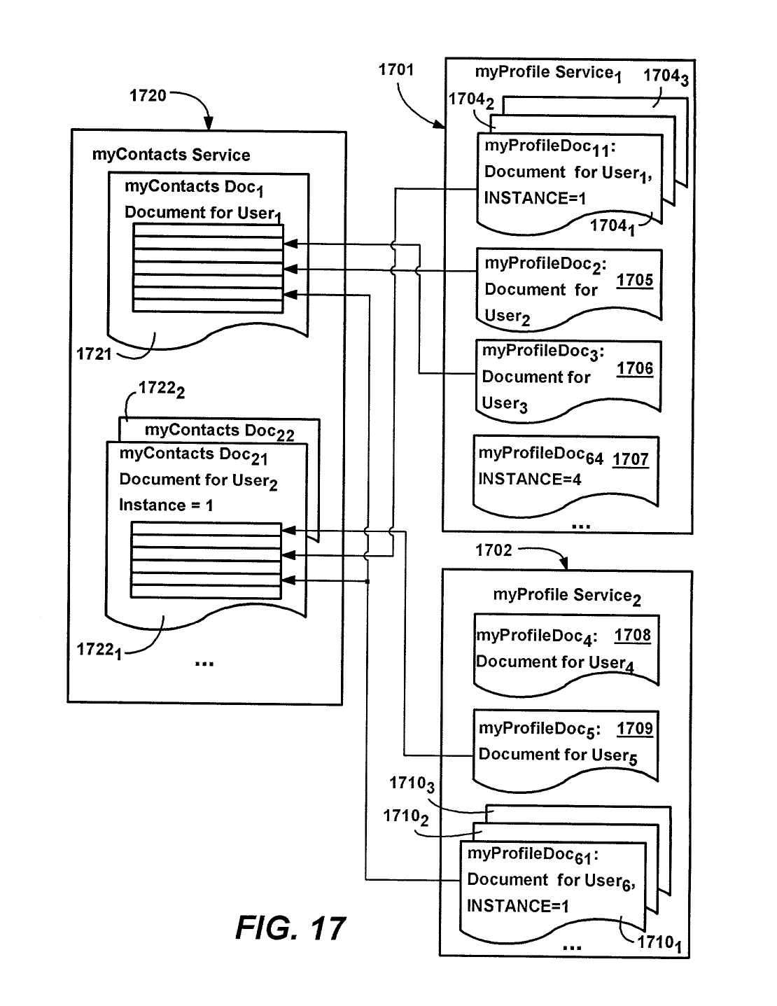

As represented in FIG. 17/20, that myContacts service has subscriptions in the two different myProfile services 1701 and 1702; it is similarly likely that a given publisher will publish to multiple .NET services. Finally, it should be possible for a single service to act both as a subscriber and a publisher (e.g., in the whitelist example, myContacts is a publisher; in the Live Contacts example, it is a subscriber). Thus, as represented in FIG. 17/20, when the profile information for myProfileDoc₆₁ changes, this information should be published by myProfile service₂ 1702, to myContacts service 1720, as both myContactsDoc₁ 1721 and myContactsDoc₂₁ 1722₁ have subscribed for the service. SSCP enables the publishing of data as changes occur, via the push model. Furthermore, in keeping with the present invention, the publisher should make all attempts to batch the changes to maximally utilize bandwidth.

In FIG. 17/20, note that only myContactsDoc₂₁ subscribes to the profile changes of myProfileDoc₅. Thus, when User₅'s profile is changed, myProfile should publish the changes only to myContactsDoc₂₁, and myContactsDoc₁ should not see these changes. Returning to User₆, assume that User₁'s role in myProfileDoc₆₁ is that of an associate; the role of User₂ is that of a friend. When a myProfile service publishes the data, it should send data visible to an associate to myContactsDoc, and data visible to a friend to myContactsDoc₂₁. As should be apparent, SSCP sends changes only to subscribed documents (user/instance) within a subscribing service, and determines the role of each subscribing user, and filter the data based on the role. To this end, the publisher maintains information about documents wanting subscriptions, which is determined by the OID/INSTANCE pair (myContactsDoc₁ and myContactsDoc₂₁). For each subscribing document, the publisher also maintains information about the document it is subscribing to (for myContactsDoc₁, this is myProfileDoc₂ and myProfileDoc₃ in myProfile Service₁), and about the role played by the owner of the subscribing document (for myProfileDoc₆₁ in myProfile Service₂, this is associate for myContactsDoc₁, friend for myContactsDoc₂₁).

In order for the publisher to keep this information current, the subscriber should notify the publisher whenever one of its users wants to unsubscribe or add a new subscription. Note that technically, it is a document that subscribes; that is, a user specifies an instance of the service which wants to act as a subscriber, but for purposes of description the user can be thought of as a subscribing. By way of example, consider For example, User₁ wants to add User₄ into his live contact list and remove User₆. SSCP should allow for transmission of this information from subscriber to publisher. SSCP allows the subscriber to send subscription updates to the publisher.

As above, the alternative embodiment described in this section provides robustness, to guarantee that the publisher and subscriber see the messages that they are supposed to see. At the most fundamental level, the publisher or subscriber need to know that their messages have reached the destination, whereby a message from the sender has a corresponding acknowledgement (ACK) returned from the receiver. The ACK need not be synchronous with respect to the message, and can instead be sent/received asynchronously.

The robust protocol of the present invention also handles the failures of publishers or subscribers, which is generally accomplished by resending a request until a response is received. However, to prevent a flood of retry messages in case of a catastrophic failure at the destination, a limited number of retries are specified, after which no further attempts are made for a longer time. This is accomplished via a reset interval (which is relatively much longer than the retry interval) after which the entire retry process begins.

A more subtle type of failure occurs when, for example, a publisher sends a request to the subscriber, informing it of the change in a stored profile, the subscriber processes the request, and sends a response to the publisher, but the network connection between the subscriber and the publisher has a transient failure and the response does not reach the publisher. As described above, to retry, the publisher resends its request. For the protocol to work correctly, the subscriber recognizes that this is a redundant request that has already been processed. In other words, a request should be processed only once even if it is sent multiple times; alternatively, the request could be processed any number of times, but the next result should be as if it was processed only once. As described above, in SSCP, retries are idempotent.

A typical service manages gigabytes of data, partitioned over millions of users. This means that in its role as a publisher, the source data will be frequently, if not almost constantly, changing. For efficiency, every change is not published immediately, but instead change requests are batched, and send occasionally (e.g., periodically). To this end, the protocol handler at the service periodically wakes up after a specified interval and sends the batched messages, as described above with respect to FIG. 6.

As generally represented in FIG. 6, SSCP is implemented at a publisher (service) 600 and subscriber (service) 610 by respective protocol handlers 602, 612, such as daemon processes or the like running with respect to a service. The publisher 600 and subscriber 610 exchange messages, and use this as a mechanism to communicate changes.

The requirements of the protocol dictate that SSCP handlers 602, 612 maintain several pieces of data, the sum total of which represents the state of a publisher or subscriber. As conceptually represented in FIG. 6, this data can be viewed as being segmented over several data structures 604-618. Note however that the arrangements, formats and other description presented herein are only logically represent the schema; the actual storage format is not prescribed, and an implementation may store in any fashion it deems fit as long as it logically conforms to this schema.

A publisher 600 communicates with a subscriber 610 using request and response messages. For example, when data changes at the publisher 600, the publisher 600, sends a request message to the subscriber 610 informing the subscriber that data has changed, normally along with the new data. The subscriber 610 receives the message, makes the required updates, and sends back an ACK message acknowledging that the message was received and that the changes were made. A subscriber 610 can also send a request message, such as when the subscriber 610 wants to subscribe or un-subscribe to a piece of datum. When the publisher 600 receives this message, the publisher 600 updates its list of subscriptions (in a publications table 608) and sends back a response acknowledging the request. Note that SSCP is agnostic to whether a response message for a given request is synchronous or asynchronous.

Thus, there are two primary parts to SSCP, a first from the publisher to the subscriber, which deals with sending changes made to the publisher's data, and a second from subscriber to the publisher, which deals with keeping the list of subscriptions synchronized. Furthermore, every service is required to provide notification to all other services that have subscriptions with it, or services with which it has subscriptions, when it is going offline or online.

The table below summarizes request messages, each of which having a corresponding response (e.g., ACK) message.

| Message | Description | Type | From/To |
|---|---|---|---|
| updateSubscriptionData | Used by the publisher to | Request | Publisher |
| | publish changes to its data | | to |
| | | | Subscriber |
| updateSubscriptionDataResponse | Used by the subscriber to | Response | Subscriber |
| | ack updateSubscriptionData | | to |
| | | | Publisher |
| updateSubscriptionMap | Used by the subscriber to | Request | Subscriber |
| | inform the publisher that | | to |
| | subscriptions have been | | Publisher |
| | added or deleted | | |
| updateSubscriptionMapResponse | Used by the publisher to | Response | Publisher |
| | ack updateSubscriptionMap | | to |
| | | | Subscriber |
| serviceStatus | Used by both publisher and | Request | Both |
| | subscriber to inform that | | directions |
| | they are going offline, or | | |
| | have come online | | |
| serviceStatusResponse | Used by both publisher and | Response | Both |
| | subscriber to ack | | directions |
| | serviceStatus request | | |

Protocol parameters are supported by both the publisher and the subscriber and control the behavior of the protocol.

As noted above, SSCP supports the ability to batch request messages. Whenever there is a need to send a request message, such as when there are changes in publisher data or subscriptions, the service puts the corresponding request message into a publisher message queue 606. Periodically, the protocol handler 602 in the publishing service 600 wakes up and processes the messages in the queue 606. This period is called as the UpdateInterval, and is a configurable parameter.

To satisfy the robustness requirement, the publisher's protocol handler 602 needs to periodically resend requests until the publisher service 600 receives an acknowledge message (ACK). If the ACK for a message is successfully received, this message is purged from the queue 606. Until then, the message remains in the queue, flagged as having been sent at least once, so it will be retried at the next update interval. The number of times the publisher the publisher service 600 retries sending a message to the subscriber service 610 is configurable by the parameter RetryCount, i.e., after retrying this many times, the publisher service 600 assumes that the subscriber service 610 is dead. Then, once the maximum number of retries is over, the publisher service 600 waits for a relatively longer time. Once this longer time is elapsed, the publisher service 600 sets the RetryCount parameter to zero and begins resending the queued up requests over again. This longer time (before beginning the retry cycle), is configurable by the parameter ResetInterval.

Below is the summary of these protocol parameters:

| Parameter | Use |
|---|---|
| UpdateInterval | The interval after which the protocol handler wakes |
| | up and processes batched requests. |
| RetryCount | The number of times we retry a connection before |
| | assuming the remote service is dead. |
| ResetInterval | The interval after which a service marked as dead is |
| | retested for alive-ness. |
| BoxcarLength | The maximum number of sub-messages to chain |
| | together on a given boxcar. |

Thus, to implement SSCP, the protocol handlers 602, 610 at the publisher and subscriber, respectively, track of several pieces of information, such as in their respective tables 604-618.

As with .NET in general, SSCP relies on the entities (services and users) being uniquely identifiable by the use of identifiers, e.g., every user in .NET has a unique identifier assigned by the Microsoft® Passport service. Each service, be it acting as a publisher or subscriber, also has a unique identifier, and in practice, a service ID will be a certificate issued by a certification authority.

SID Generic Service Identifier

PSID Publishing Service Identifier

SSID Subscribing Service Identifier

POID Publishing Owner Identifier (PUID of myPublishingService user)

PINST Instance ID of POED

SOID Subscribing Owner Identifier (PUID of mySubscribingService user)

SINST Instance ID of SOID

To send a request or a response, the service needs to know where the target is located. For purposes of the protocol a service is identified either by just the URL or by a series of URL/CLUSTER entries. To ensure proper handling of the number of retries for a particular service, the handler needs to keep track of how many retries have been done. All this information is kept in the CONNECTIONS table, which is used by both publishers and subscribers:

| | | | |
|---|---|---|---|
| SID | URL | CLUSTER | RETRY |

| | |
|---|---|
| SD | The primary key for this table; the service ID of a |
| | Subscriber or Publisher |
| URL | the URL at which the service is expecting requests |
| CLUSTER | the cluster number of this service |
| RETRY | the current retry number of the service |

There is one entry in this table for every target service. For a publisher, this means every service that has subscriptions with it; for a subscriber, this means every publisher that it has subscriptions with. When RetryCount<RETRY<ResetInterval, the target service is assumed to be dead. Note that when an unknown service (i.e., one that is not present in the CONNECTIONS table) sends a request, an attempt is made to contact it immediately, without waiting until the next interval.

The publisher tracks the users across the services with which it has subscriptions. This is done in the PUBLICATIONS table. The PUBLICATIONS table, used by the publisher, looks like:

| | | | | | | | | |
|---|---|---|---|---|---|---|---|---|
| PKEY | POID | PINST | SOID | SINST | SSID | SCN | ROLE | TOP- |
| | | | | | | | | IC |

wherein:

| | |
|---|---|
| PKEY | The primary key for this table; note that the columns POID, PINST, |
| | SOID, SINST and SSID form a candidate key |
| POID | Owner-ID of the publisher |
| PINST | Instance ID of the publishing service |
| SOID | Owner-ID of the subscriber |
| SINST | Instance ID of the subscribing service |
| SSID | ID of the subscribing service |
| SCN | Last known change number of an add or delete request received from the |
| | subscriber. For more information, see section “Error! Reference source |
| | not found.”. |
| ROLE | Subscribing Owner-ID role in the publishing Owner-ID/Instance's |
| | roleList for this document |
| TOPIC | If the subscribing document is having multiple subscriptions with a |
| | publishing document, then a TOPIC is used to distinguish them. |

There is one row in this table for each document/topic/subscribing service combination. The PUBLICATIONS table be made visible at the schema level, but should be read only.

Given a publishing service P and a subscribing service S, there will exist a (possibly empty) set SM={(PO₁, PI₁, SOᵢ, SIᵢ, Tᵢ), for i=1 to n} such that:

1) POᵢ is a user managed by P

2) SOᵢ is a user managed by S

3) The document (SO₁, SIᵢ) subscribes to the document (POᵢ, PIᵢ) with topic Tᵢ.

The set SM is referred to as the subscription map of P with respect to S, wherein the subscription map may be obtained by the following query:

SELECT POID, PINST, SOID, SINST, TOPIC FROM PUBLICATIONS WHERE SSID=S

The PUBLICATIONS_QUEUE table is used by the publisher to batches the requests for the protocol handler to send when the interval is achieved, e.g., the UpdateInterval timer goes off. Also, the publisher is required to retry requests for which a response has not been received. The publisher thus tracks the messages that need to be sent for the first time, or those that need to be resent. This is done in the PUBLICATIONS_QUEUE table, which looks like this:

| | | |
|---|---|---|
| PQKEY | PKEY | PCN |

wherein:

| | |
|---|---|
| PQKEY | Primary key for this table |
| PKEY | Identifies the row in PUBLICATIONS table - effectively pointing to a |
| | document in the publisher service, the changes to which needs to be |
| | published to a subscribing document |
| PCN | Last known change number of the publisher's data which was sent to the |
| | subscriber |

The PCN field is required to ensure correct updates in situations when multiple updates happen to the underlying data before a response is received from the subscriber. By way of example, suppose that change number five (5) occurs during update interval ten (10); a row is inserted into the PUBLICATION_QUEUE, with PCN=(5). When the interval timer goes off for the tenth time, a message is sent to the subscriber, with the changes relating to PCN=5. Assume that for whatever reason, a response from the subscriber is not received for this message, and during update interval eleven (11), change number six (6) occurs. This causes the PCN in the PUBLICATION_QUEUE to be updated from five (5) to six (6). At this time, the response comes back from the subscriber for the original message containing the change number that it had received, which is equal to five (5). The publisher compares this change number with the change number that it has stored in the PUBLICATION_QUEUE table, and finds that the one in the table has a value of 6. So, it knows that more changes need to be sent to the subscriber (those corresponding to change number six (6)), and hence it retains the row in the queue. Note that if during update interval eleven (11), change number six (6) did not occur, then the PCN in the PUBLICATION_QUEUE would still be five (5) and the publisher's comparison of this change number with the change number that it has stored in the PUBLICATION_QUEUE, would be true and the publisher would have deleted the row from the queue.

As described above, the Publication Queue Store does not store messages, but the information needed to create the messages. One reason is that the storage required by these messages is likely to be huge, so rather than storing the actual messages in the table, during an update interval, the publisher uses entries in this table to look up the ROLE of the owner of the subscribing document (from the PUBLICATIONS table), and generates the request message at the time of sending it. Another reason for not storing messages deals with multiple updates occurring within a single updateinterval. In this case multiple copies of the messages would needlessly get generated and then overwritten. Another reason to not store messages in the queue is that messages are collated so that similar data payloads get combined into a single outbound request. Generating messages for every queue entry would mean a redundant effort, discarded at message send time.

The subscriber uses a SUBSCRIPTIONS table to keep track of the subscriptions that are in effect:

| | | | | | | | |
|---|---|---|---|---|---|---|---|
| SKEY | SOID | SINST | POID | PINST | PSID | PCN | TOPIC |

wherein:

| | |
|---|---|
| SKEY | The primary key for this table; note that the columns POID, |
| | PINST, SOID, SINST and PSID form a candidate key |
| SOID | Owner-ID of the subscriber |
| SINST | Instance ID of the subscribing service |
| POID | Owner-ID of the publisher |
| PINST | Instance-ID of the publishing service |
| PSID | ID of the publishing service |
| PCN | Last known change number of the publisher's data received |
| | from the publisher |
| TOPIC | If the subscribing document is having multiple subscriptions |
| | with a publishing document, then a TOPIC is used to |
| | distinguish them. |

Note that the existence of a row in this table implies that the associated publishing service has one or more associated entries in its PUBLICATIONS table. The PCN field is required to ensure that publisher retries are idempotent.

Recall that the subscriber batches requests and the protocol handler sends the requests every time the UpdateInterval timer goes off. Also, the subscriber is required to retry requests for which a response has not been received. Thus it needs to keep track of all messages that need to be sent for the first time, or need to be resent, which is done in the SUBSCRIPTIONS_QUEUE table:

| | | | | | | | |
|---|---|---|---|---|---|---|---|
| SQKEY | SOID | SINST | TOPIC | POID | PINST | OPERA- | SCN |
| | | | | | | TION | |

wherein:

| | |
|---|---|
| SQKEY | The primary key for this table |
| SOID | Owner-ID of the subscriber |
| SINST | Instance ID of the subscribing service |
| TOPIC | The TOPIC ID for this subscription |
| POID | Owner-ID of the publisher |
| PINST | Instance-ID of the publishing service |
| OPERATION | Boolean; TRUE is addition and FALSE is deletion of |
| | subscription |
| SCN | Change number that keeps track of how many times this |
| | subscription has been added or deleted. |

Note that the subscription queue does not store messages. Instead, the OPERATION field in the Queue indicates whether this request is to add a subscription or delete a subscription. During an update interval, the protocol handler simply looks at the OPERATION field and dynamically generates the appropriate request message. Thus, even though the subscription queue does not store the message, it has the information needed to formulate the message. Further, note that the subscription queue has multiple columns, while the publication-queue has only a key, because the publication queue only needs to identify which one of the pre-existing subscriptions needs a data update. Thus, it only needs to store the row-id in the PUBLICATIONS table. However, the subscription queue sometimes needs to add a subscription, and the information needed for this purpose should be in the subscription queue. The SCN field is required to ensure correctness in cases where the user adds/deletes the same subscription multiple times—for example, the user adds a subscription, and then deletes it or deletes a subscription and then adds it—before the original request was sent to, and a response received from, the publisher. In such cases, each change of mind on the part of the user is treated as a change, and is assigned a change number. This number is passed back and forth between subscriber and publisher in the request and response messages and ensure that the multiple adds and deletes are processed properly.

This updateSubscriptionData message is provided when a user's document gets modified. The publishing service checks the contents of the PUBLICATIONS table for interested subscribers by issuing the following logical query:

SELECT * FROM PUBLICATIONS WHERE POID=%AFFECTED_POID% AND PINST=%AFFECTED_PINST% AND TOPIC=%TOPIC% GROUP BY SSID, ROLE

The publisher uses this information to construct an updateSubscriptionData message to each affected subscribing service. For the set of distinct ROLES used within the result set an associated set of filtered data is created in a service dependent manner. Then, the data is factored by SSID and each affected subscriber is sent an updateSubscriptionData message (actually the messages are queued up and sent the next time the Update Interval timer goes off).

The message format for updateSubscriptionData follows the following schema using the XMI conventions:

<updateSubscriptionData topic=”###”>_{1..1}

| | |
|---|---|
| <updateData | publisher=”...” |

instance=”...”
changeNumber=”###”>_{0..unbounded}

<subscription subscriber=”...”

instance=”...”/>=”...”_{0..unbounded}

<subscriptionData>_{1..1}</subscriptionData>

</updateData>

</updateSubscriptionData>

The data contained in the subscriptionData entity is defined by the participants in the service-to-service communication. Documents which engage in multiple publish/subscribe relationships should use the @topic attribute to disambiguate the meaning of the content. The @topic attribute is a URI and is specific to the instance of service-to-service communication. For instance the myProfile to myContacts communication topic could use a URI like: urn:microsoft.com:profile-contacts:1.0. No service should attempt to accept an updateSubscriptionMap request for any conversation that they have not been explicitly configured to accept.

The message format for updateSubscriptionDataResponse follows the following schema using the XMI conventions:

<updateSubscriptionDataResponse topic=”###”>_{1..1}

<updatedData publisher=”...” changeNumber=”...”

instance=”...”>_{0..unbounded}

<subscription subscriber=”...”

instance=”...”/>=”...”_{0..unbounded}

</updatedData>

<deleteFromSubscriptionMap subscriber=”...”

instance=”...” />_{0..unbounded}

</updateSubscriptionDataResponse>

The function of <updatedData> is to inform the publisher, while <deleteFromSubscriptionMap> is used by the subscriber to tell the publisher that this SOID/SINST has been deleted.

When a set of users change their subscription statuses, the set of changes are sent to the affected Publishers within an updateSubscriptionMap message. When the Publisher receives this message it updates the records in the PUBLICATION_TABLE. It is important to the correctness of the protocol that all updates are handled robustly. In particular it is not an error to add an entry more than once. Likewise it is not an error to delete a non-existent entry. In both these cases it is important to format the response so that success is indicated for these cases.

The message format for updateSubscriptionMap follows the following schema using the XMI conventions:

<updateSubscriptionMap topic=”###”>_{1..1}

<addToSubscriptionMap subscriber=”...”

```
  instance=”...”
  scn=”###”>_{0..unbounded}
```

<subscription publisher=”...”

instance=”...”/>=”...”_{0..unbounded}

</addToSubscriptionMap>

<deleteFromSubscriptionMap subscriber=”...”

instance=”...”
scn=”###”>_{0..unbounded}

<subscription publisher=”...”

instance=”...”/>=”...”_{0..unbounded}

</deleteFromSubscriptionMap>

</updateSubscriptionMap>

The addToSubscriptionMap section is used to make additions to the subscriptionMap, while the deleteFromSubscriptionMap removes entries.

The message format for updateSubscriptionMapResponse follows the following schema using the XMI conventions:

<updateSubscriptionMapResponse topic=”###”>_{1..1}

<addedToSubscriptionMap subscriber=”...”

instance=”...”
scn=”###”>_{0..unbounded}

<subscription publisher=”...”

instance=”...”/>_{0..unbounded}

</addedToSubscriptionMap>

<deletedFromSubscriptionMap subscriber=”...”

instance=”...”
scn=”###”>_{0..unbounded}

<subscription publisher=”...”

instance=”...”/>_{0..unbounded}

</deletedFromSubscriptionMap>

<unknownPID publisher=”...” instance=”...”/>_{0..unbounded}

</updateSubscriptionMapResponse>

The <addedToSubscriptionMap> and <deletedFromSubscriptionMap> provide status information, while the entity <unknownPID> is used in situations where a publishing user is deleted.

Services also need to send out messages when they come on-line, e.g., to wake up other services which have stopped sending them messages. To this end, whenever a service is going offline or coming online, the service should send out the following message to its partner services stored in its connections table (604 if a publisher, 614 if a subscriber, although it is understood that a service may be both a publisher and a subscriber and thus access both tables at such a time time). The format of this message using the XMI conventions is:

<serviceStatus>1..1

<online/>0..1
<offline/>0..1

</serviceStatus>

Only one of the online or offline entities should be sent in any given message.

There is no defined response format for this message, as the normal .NET My Services ACK or fault response supplies the information needed.

SSCP is designed so that the protocol does not impose any indigenous restrictions on what can or cannot be subscribed to. At the one extreme, a service can request a subscription to all of publisher's data (at least, all that is visible to it). However, it may also subscribe to only a subset of it. The “topic” attribute of updateSubscriptionMap message is used to specify this. From the perspective of SSCP, a topic is simply an identifier (mutually agreed upon by the subscriber and publisher) which specifies what the subscriber wants to subscribe to. For instance, if myInbox service only wants to subscribe to an email address in myContacts service (which is the case for whitelists) then one way of using “topic” attribute would be:

1) myInbox and myContacts agree that the identifier “emailOnly” indicates that only the email address should be subscribed to.

2) myInbox sends an updateSubscriptionMap request to myContacts in which it sets topic=“emailOnly”.

3) When email data for a contact changes, the publisher sends knows to send out an updateSubscriptionData message with only the email changes to the subscriber; in this message, it sets topic=“emailOnly”.

Because the value of the topic attribute is included in updateSubscriptionData message, a subscribing document S can have multiple subscriptions with a publishing document P where each subscription differs by only the topic attribute.

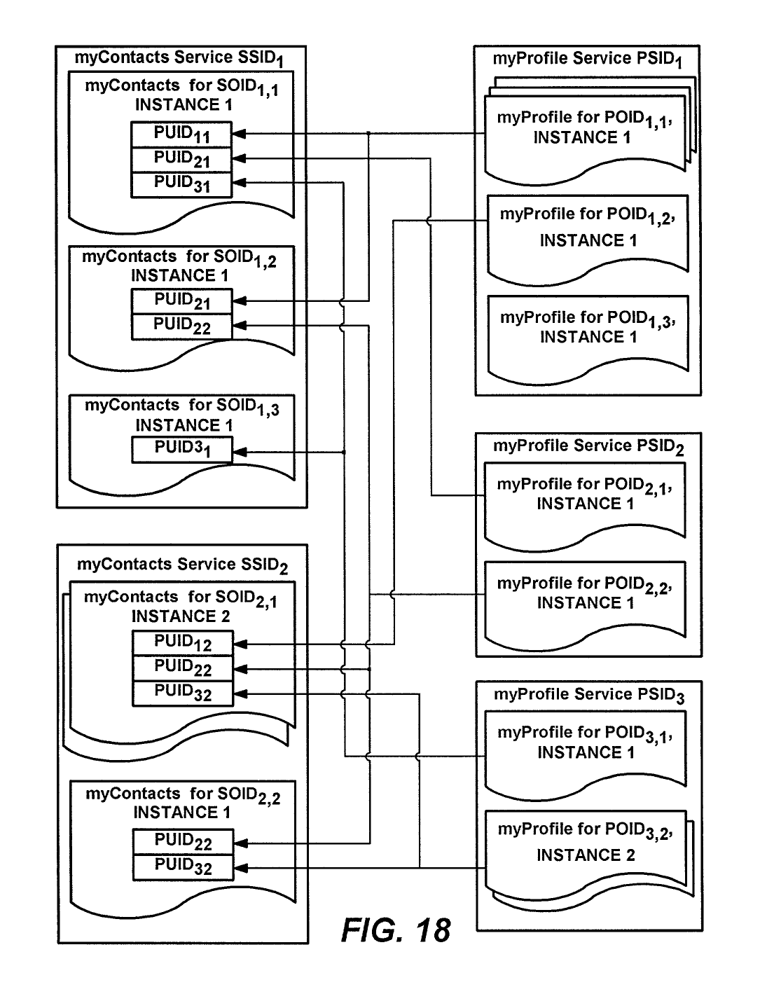

By way of explanation of the operation of the present invention, the protocol handler wakes up when the interval timer goes off, and the handler sends the queued requests, or a request is received from another service, and the handler performs the requested action and sends a response. By way of example using the Live Contacts operation, consider FIG. 18/21, in which there are three myProfile services whose IDs are PSID₁, PSID₂, and PSID₃. In FIG. 18/21:

PSID₁ contains the profile documents of three users: POID₁₁, POID₁₂, POID₁₃

POID₁₁ has three instance documents: 1, 2, and 3.

POID₁₂ and POID₁₃ have one instance document each.

PSID₂ contains profile documents of two users: POID₂₁ and POID₂₂, each having one instance document.

PSID₃ contains profile documents of two users: POID₃₁ and POID₃₂.

POID₃₁ has one instance document.

POID₃₂ has two instance documents: 1 and 2.

There are two myContacts services whose IDs are SSID₁ and SSID₂.

SSID₁ manages contact documents of three users: SOID₁₁, SOID₁₂, and SOID₁₃, each with one instance document.

SSID₂ manages contact documents of two users: SOID₂₁ and SOID₂₂.

SOID₂₁ has two instance documents: 1 and 2.

SOID₂₂ has one instance document.

The initial subscription maps look like below, with each document represented by the tuple (owner-id, instance):

PSID₁:

(POID₁₁,1): friend(SOID₁₁,1), associate(SOID₁₂,1)

(POID₁₂,1): other(SOID₂₁,2)

(POID₁₃, 1):

PSID₂:

(POID₂₁,1): friend(SOID₁₁,1)

(POID₂₂,1): friend((SOID₂₁,2),(SOID₂₂,1)),

associate(SOID₁₂,1)

PSID₃:

(POID₃₁, 1): associate(SOID₁₁,1), other(SOID₁₃,1)

(POID₃₂,2): friend(SOID₂₁,2), associate(SOID₂₂,1)

SSID₁:

(SOID₁₁,1): (POID₁₁,1), (POID₂₁,1), (POID₃₁,1)

(SOID₁₂,1): (POID₁₁,1), (POID₂₂,1)

(SOID₁₃,1): (POID₃₁,1)

SSID₂:

(SOID₂₁,2): (POID₁₂,1), (POID₂₂,1), (POID₃₂,2)

(SOID₂₂,1): (POID₂₂,1), (POID₃₂,2)

The two contacts services each include a CONNECTIONS table (for simplicity, information such as cluster, URL, and so on, are not shown below).

For SSID₁ the connections table includes:

SSID₁ CONNECTIONS Table
PSID₁
PSID₂
PSID₃

while for SSID₂ the connections table includes:

SSID₂ CONNECTIONS Table
PSID₁
PSID₂
PSID₃

The three profile services each contain a PUBLICATIONS table (for simplicity, information such as PKEY or SCN columns are not shown below).

For PSID₁ this looks like:

PSID₁ PUBLICATIONS Table

| POID | PINST | SOID | SINST | SSID | ROLE |
|---|---|---|---|---|---|
| POID₁₁ | 1 | SOID₁₁ | 1 | SSID₁ | friend |
| POID₁₁ | 1 | SOID₁₂ | 1 | SSID₁ | associate |
| POID₁₂ | 1 | SOID₂₁ | 2 | SSID₂ | other |

And for PSID₂ this looks like:

PSID₂ PUBLICATIONS Table

| POID | PINST | SOID | SINST | SSID | ROLE |
|---|---|---|---|---|---|
| POID₂₁ | 1 | SOID₁₁ | 1 | SSID₁ | friend |
| POID₂₂ | 1 | SOID₁₂ | 1 | SSID₁ | associate |
| POID₂₂ | 1 | SOID₂₁ | 2 | SSID₂ | friend |
| POID₂₂ | 1 | SOID₂₂ | 1 | SSID₂ | friend |

Finally for PSID₃ this looks like:

PSID₃ PUBLICATIONS Table

| POID | PINST | SOID | SINST | SSID | ROLE |
|---|---|---|---|---|---|
| POID₃₁ | 1 | SOID₁₁ | 1 | SSID₁ | associate |
| POID₃₁ | 1 | SOID₁₃ | 1 | SSID₁ | other |
| POID₃₂ | 2 | SOID₂₁ | 2 | SSID₂ | friend |
| POID₃₂ | 2 | SOID₂₂ | 1 | SSID₂ | associate |

Updating Subscription Map

If during an update interval on SSID₁ document SOID₁₁/instance1 adds links to the documents POID₁₂/instance1 and POID₃₂/instance2 and deletes the link from POID₁₁/instance1, while SOID₁₂/instance1 deletes the link from POID₁₁/instance1 the contents of the SUBSCRIPTIONS_QUEUE for SSID₁ is:

SSID₁ SUBSCRIPTIONS_QUEUE

| SOID | SINST | POID | PINST | PSID | OPERATION | SCN |
|---|---|---|---|---|---|---|
| SOID₁₁ | 1 | POID₁₂ | 1 | PSID₁ | TRUE | 0 |
| SOID₁₁ | 1 | POID₃₂ | 2 | PSID₃ | TRUE | 0 |
| SOID₁₁ | 1 | POID₁₁ | 1 | PSID₁ | FALSE | 0 |
| SOID₁₂ | 1 | POID₁₁ | 1 | PSID₁ | FALSE | 0 |

When processed this will generate two different updateSubscriptionMap requests that are sent to the two affected myProfile services. PSID₁ is sent:

<updateSubscriptionMap topic=”####”>

<addToSubscriptionMap subscriber=”SOID₁₁” instance=”1”

scn=”0”>

<subscription publisher=”POID₁₂” instance=”1”/>

</addToSubscriptionMap>
<deleteFromSubscriptionMap subscriber=”SOID₁₁”

instance=”1” scn=”0”>

<subscription publisher=”POID₁₁” instance=”1”/>

</deleteFromSubscriptionMap>
<deleteFromSubscriptionMap subscriber=”SOID₁₂”

instance=”1” scn=”1”>

<subscription publisher=”POID₁₁” instance=”1”/>

</deleteFromSUbscriptionMap>

</updateSubscriptionMap>

And PSID₃ is sent:

<updateSubscriptionMap topic=“####”>

<addToSubscriptionMap subscriber=“SOID₁₁”

instance=“1” scn=“0”>

<subscription publisher=“POID₃₂” instance=“2”/>

</addToSubscriptionMap>

</updateSubscriptionMap>

After receiving these messages each myProfile service updates the contents of their PUBLICATIONS table as follows (with the TOPIC and SCN columns not shown).

For PSID₁ the resulting table looks like:

PSID₁ PUBLICATIONS Table

| POID | PINST | SOID | SINST | SSID | ROLE |
|---|---|---|---|---|---|
| POID₁₂ | 1 | SOID₂₁ | 2 | SSID₂ | Other |
| POID₁₂ | 1 | SOID₁₁ | 1 | SSID₁ | associate |

And for PSID₃ the resulting table looks like:

PSID₃ PUBLICATIONS Table

| POID | PINST | SOID | SINST | SSID | ROLE |
|---|---|---|---|---|---|
| POID₃₁ | 1 | SOID₁₁ | 1 | SSID₁ | associate |
| POID₃₁ | 1 | SOID₁₃ | 1 | SSID₁ | Other |
| POID₃₂ | 2 | SOID₁₁ | 1 | SSID₁ | Other |
| POID₃₂ | 2 | SOID₂₁ | 2 | SSID₂ | Friend |
| POID₃₂ | 2 | SOID₂₂ | 1 | SSID₂ | associate |

Assuming from the original configuration that document POID₁₁/instance1 changes the contents on his or her profile. So PSID₁ constructs the following updateSubscriptionData message to SSID₁:

<updateSubscriptionData topic=“####”>

<updateData publisher=“POID₁₁” instance=“1”

changeNumber=“###”>

<subscription subscriber=“SOID₁₁” instance=“1”/>
<subscriptionData>friend-info</subscriptionData>

</updateData>
<updateData publisher=“POID₁₁” instance=“1”

changeNumber=“###”>

<subscription subscriber=“SOID₁₂” instance=“1”/>
<subscriptionData>associate-info</subscriptionData>

</updateData>

</updateSubscriptionData>

Note that the message is split between two updateData blocks because of different roles being assigned. If POID₂₂/instace1 was to change his profile information this would result in PSID₂ sending out two updateSubscriptionData messages to SSID₁ and SSID₂.

<!-- to SSID₁-->

<updateSubscriptionData topic=“####”>

<updateData publisher=“POID₂₂” instance=“1”

changeNumber=“###”>

<subscription subscriber=“SOID₁₂” instance=“1”/>
<subscriptionData>associate-info</subscriptionData>

</updateData>

</updateSubscriptionData>
<updateSubscriptionData topic=“####”>

<!-- to SSID₂-->

<updateSubscriptionData topic=“####”>

<updateData publisher=“POID₂₂” instance=“1”

changeNumber=“###”>

<subscription subscriber=“SOID₂₁” instance=“2”/>
<subscription subscriber=“SOID₂₂” instance=“1”/>
<subscriptionData>friend-info</subscriptionData>

</updateData>

</updateSubscriptionData>

Note in this case the message to SSID₂ only contains one copy of the data optimizing for identical roles.

As described herein, SSCP is a robust protocol which is able to handle many different kinds of failure scenarios, including:

1) Publisher fails

2) Subscriber fails

3) The link between publisher and subscriber goes down before the subscriber can respond (after it has received a request)

4) The link between publisher and subscriber goes down before the publisher can respond (after it has received a request)

5) Publisher loses the subscription map

6) Subscriber loses published data

These failure scenarios are handled by the protocol via message retries and idempotency.

In the following explanation, it is assumed that the publisher sends the request message, however this applies equally well when the subscriber sends the request message.

When the publisher sends a request message, SSCP follows the following algorithm:

1) Publisher sends a message from the PUBLICATIONS_QUEUE.

2) It waits for a response to this message

a) If it gets a response, it deletes the message from the queue

b) Otherwise, it keeps the message in the queue and resends it the next time the Update Interval timer goes off.

3) As explained herein, the number of times a message is resent is bounded by a maximum after which the subscriber is considered dead. It is tested for alive-ness after a “long time” and the process begins all over.

4) This method ensures that the subscriber does not miss an updateSubscriptionData message.

As described above, retry attempts should idempotent, i.e., multiple retries of a request should behave as if the request had been sent only once. Idempotency is achieved by keeping track of the change number, or PCN (which is a column in the PUBLICATIONS and SUBSCRIPTIONS tables). Note that the underlying service implementation has change number data, and keeps track of it, independent of SSCP. As used herein such changed numbers are logically reflected as an integer sequence, however in general, the PCNs need not be sequential, but instead may be whatever the service has, as long as it increases or decreases monotonically. Note also that the smallest unit of change is a .NET blue node, wherein currently a blue node is the smallest query-able, cacheable, unit of data in .NET.

Change numbers generally work as follows:

When a fresh subscription is created, the publisher adds a row into the PUBLICATIONS table, with PCN being set to 0 to indicate that no data has yet been exchanged. The subscriber also keeps track of the value of this PCN in its SUBSCRIPTIONS table. Whenever the publisher sends an updateSubscriptionData request to the subscriber, it includes the value of PCN that it currently has for this (e.g., blue) node. It records this PCN in the PUBLICATIONS table. On receiving the updateSubscriptionData message, the subscriber updates its copy of the PCN (present in the PCN field of SUBSCRIPTIONS table) to the new value. If, due to a transient network failure, the publisher fails to receive the response message from the subscriber, it resends the request message again at the next update interval. On receiving this request, the subscriber inspects the PCN; it knows that it has already processed this message because the publisher's change number in the message is the same as the PCN that it has, and thus treats this as a no-op and sends back a response. The publisher deletes this message from the message queue, and the net result is, any message received multiple times by the subscriber is processed exactly once—i.e., retries are idempotent.

The subscriber achieves idempotency is by the following rules: when a publisher receives a request to add a preexisting entry to its subscription map, it should treat this as a no-op and not return an error. When the publisher receives a request to delete a non-existent entry from its subscription map, it should treat this as a no-op and not return an error. As can be appreciated, multiple add or delete from subscription map requests behave as if there of only one such request.

The SCN field is required to ensure correctness in cases where the user adds/deletes the same subscription multiple times—for example, the user adds a subscription, and then deletes it or deletes a subscription and then adds it—before the original request was sent to, and a response received from, the publisher. In such cases, each change of mind on the part of such a user is treated as a change, and is assigned a change number. Change numbers are monotonically increasing. Here is how change numbers (SCN) are treated with in the publisher and subscriber algorithms:

A) Whenever a user adds or deletes a subscription, the subscriber looks at its subscription queue to see if there exists a pending request in queue from this user/instance pair to the corresponding publishing document.

I) If there exists such a pending request, then the subscriber replaces the request with the new one.

II) If a pending request does not exist, then the subscriber inserts the new request.

III) In either case, the SCN is updated to a new increased value.

B) The net result of the above is: at any given point, the subscription queue contains only the last request made by the user; but the change number has increased every time the user changes his mind.

C) The updateSubscriptionMap request includes the current value of the change number from the queue for each add or delete entity present in the request.

D) When the publisher receives an updateSubscriptionMap request, it does the following for every add/delete entity in the request:

I) If the entity is add, then:

i) If this subscription is already present in the publications table and then:

(1) if the SCN in the message is greater than the SCN that it has, then it updates to the higher value of SCN

(2) Otherwise it is ignored.

ii) Otherwise it inserts this subscription into the publications table, records the SCN.

II) If the entity is delete, and if this subscription is present in the publications table then:

i) It is deleted if the SCN in the message is greater than the SCN that the publisher has, it deletes the subscription from its publications table.

ii) Otherwise it is ignored.

In any case, it sends the SCN that it received as part of the response message.

E) When a subscriber receives an updateSubscriptionMapResponse from the publisher, it does the following for each entity in the response:

I) If there is no entry in the subscription queue corresponding to this entity, then it is ignored

II) Otherwise:

i) If the SCN in the entity is less than the SCN in the queue, then it is ignored.

ii) Otherwise, the corresponding entry in the queue is removed.

To see why this algorithm works, consider the following cases:

1) In an ordinary case (happens large majority of the time), when a User does an add (or a delete)

a) The add (delete) is stored in the queue with SCN=2

b) (Assume) This subscription does not exist (exists) at the publisher.

c) At the next update interval, the subscriber sends an updateSubscriptionMap message with an add (delete) entity for which SCN=2

d) The publisher receives this request; it adds it to (deletes it from) the publication table with SCN=2, and sends back a response with SCN=2

e) The subscriber compares the SCN in the response finds that it is the same as what is in the queue, and purges the queue.

f) Net effect: the subscription is added (deleted).

In extraordinary cases:

2) User does an Add followed by a delete within the same update interval:

a) The add is stored in the queue with SCN=2

b) The delete request overwrites the add request, and the SCN is updated to 3.

c) (Assume) This subscription does not exist at the publisher.

d) At the next update interval, the subscriber sends an updateSubscriptionMap message with a delete entity for which SCN=3

e) The publisher receives this request; since the subscription does not exist, it does nothing, and sends back a response with SCN=3

f) The subscriber compares the SCN in the response finds that it is the same as what is in the queue, and purges the queue.

3) Same as above, but add and delete happen within different update intervals

a) Add is stored in the queue with SCN=2

b) When update interval timer goes off, an updateSubscriptionMap is sent with an add entity for which SCN=2.

c) Three cases are generally possible:

i) The message reaches the publisher and it sends a response which reaches the subscriber. Call this SUCCESS case.

ii) The message reaches the publisher and it sends back a response which does not reach the subscriber. Call this PARTIAL case

iii) The message does not reach the publisher. Call this the FAILURE case.

d) In the SUCCESS case:

i) The process of addition takes place at the publisher as explained in case (1). An SCN of 2 is stored in the publication table.

ii) The user now asks that the subscription be deleted, which causes a delete to be stored in the queue with SCN=3.

iii) During the next update interval, an updateSubscriptionMap message is sent with a delete entity for which SCN=3.

iv) The process of deletion takes place as explained in case (1)

e) In the PARTIAL case:

i) Since the publisher has received the add message, the process of addition takes place at the publisher as explained in case (1). An SCN of 2 is stored in the publication table.

ii) The subscriber has not received a response for the add, so the add remains in the queue.

iii) The user now asks that the subscription be deleted, which causes a delete to be stored in the queue with SCN=3. The add has been over-written.

iv) During the next update interval, an updateSubscriptionMap message is sent with a delete entity for which SCN=3.

v) A delete is performed as explained in case (1)

vi) If, for some reason, the original response that the publisher sent for the add message now reaches the subscriber, the subscriber simply ignores it since there is no entity in the subscription queue that corresponds to this response.

f) With respect to the subscriber, the FAILURE case is logically equivalent to the PARTIAL case and is handled identically; with respect to the publisher, the only difference between PARTIAL and FAILURE is: in the FAILURE case, the delete request is a no-op since the publisher never received the add request.

The cases above have considered an add followed by a delete. Clearly, a delete followed by an add also works similarly. Furthermore, a series of adds/deletes by the user (in any order and in any interval and in any combination of the success/partial/failure cases) will also work and the right things will happen. However, there is are cases that are particularly problematic:

4) A trick case: requests arrive at the publisher out of sequence.

a) The user does an add. This request is kept in the queue with an SCN=2.

b) At the next update interval, an updateSubscriptionMap request is sent to the publisher with an add entity and SCN=2.

c) Next the user does a delete of the same subscription. This request is kept in the queue with an SCN=3.

d) At the next update interval, an updateSubscriptionMap request is sent to the publisher with an add entity and SCN=3.

e) For some strange reason, the delete request arrives at the publisher before the add request.

f) The publisher processes the delete request by removing this subscription (if it exists), and sends a response with SCN=3.

g) The subscriber deletes the corresponding entity from the queue.

h) Now the publisher receives the add request with SCN=2. According to the algorithm, it adds the subscription to its publication queue. And it sends back a response with SCN=2.

i) The subscriber ignores this response since there is no entity in the subscription queue corresponding to this response.

The net of this is, there now exists a subscription in the publisher which shouldn't be there. The net result of the trick case is that it is possible for a rogue subscription to exist at the publisher; the subscriber has no record of this subscription in its subscription table. As a result, it is possible for the subscriber to receive an updateSubscriptionData message for a subscription that does not exist. When this happens, the subscriber does the following:

A) It checks its subscription queue to see if the queue has a delete or an add message for this subscription. If there is one, then it does nothing.

B) If there isn't a delete message in the queue already, it inserts a message in the queue with an incremented SCN

C) At the next update interval, an updateSubscriptionMap message is sent to the publisher.

D) When the publisher receives this message:

I) it checks its publication queue to see if there are any pending messages to be sent to this subscription in its publication queue. If there is, these pending messages are removed.

II) It deletes the subscription from its publications table and sends a response back.

The cases above have considered an add followed by a delete, but note that a delete followed by an add also works similarly. Furthermore, a series of adds/deletes by the user (in any order and in any interval and in any combination of the success/partial/failure cases) will also work and the right things will happen. However, another case is particularly problematic:

5) A trick case: requests arrive at the publisher out of sequence.

a) The user does an add. This request is kept in the queue with an SCN=2.

b) At the next update interval, an updateSubscriptionMap request is sent to the publisher with an add entity and SCN=2.

c) Next the user does a delete of the same subscription. This request is kept in the queue with an SCN=3.

d) At the next update interval, an updateSubscriptionMap request is sent to the publisher with an add entity and SCN=3.

e) For some strange reason, the delete request arrives at the publisher before the add request.

f) The publisher processes the delete request by removing this subscription (if it exists), and sends a response with SCN=3.

g) The subscriber deletes the corresponding entity from the queue.

h) Now the publisher receives the add request with SCN=2. According to the algorithm, it adds the subscription to its publication queue. And it sends back a response with SCN=2.

i) The subscriber ignores this response since there is no entity in the subscription queue corresponding to this response.

The net of this is, there now exists a subscription in the publisher which shouldn't be there. The net result of the trick case is that it is possible for a rogue subscription to exist at the publisher; the subscriber has no record of this subscription in its subscription table. As a result, it is possible for the subscriber to receive an updateSubscriptionData message for a subscription that does not exist. When this happens, the subscriber does the following:

E) It checks its subscription queue to see if the queue has a delete or an add message for this subscription. If there is one, then it does nothing.

F) If there isn't a delete message in the queue already, it inserts a message in the queue with an incremented SCN

G) At the next update interval, an updateSubscriptionMap message is sent to the publisher.

H) When the publisher receives this message:

I) it checks its publication queue to see if there are any pending messages to be sent to this subscription in its publication queue. If there is, these pending messages are removed.

II) It deletes the subscription from its publications table and sends a response back.

Thus, this unusual case simply means that there will exist one or more rogue subscriptions at the publisher until such time that the data subscribed by these rogue subscriptions change. At this point, the protocol logic takes over and deletes the rogue subscription. Note that the vast majority of the time, the simple case (1) is what takes place, and the other cases occur only very rarely.

When the publisher fails, the publisher will not be able to respond to subscriber requests to update the subscription map, which is handled by resending the message until a response is received. Long-term or catastrophic failures are handled by having a limit on the number of retries and waiting for a “long time” before starting all over. The publisher will also not receive any responses that the subscriber may have sent to its updateSubscriptionData requests. From the point of view of the subscriber, this is logically indistinguishable from the case where the link between subscriber and publisher fails.

When the subscriber fails, it is very similar to what happens when the publisher fails. The subscriber continues to resend the updateSubscriptionMap requests until it receives a response from the publisher. As in the publisher case, the non-reception of responses by the subscriber is the same as a link failure.

A failure case can occur when the subscriber has sent an updateSubscriptionMap message, and the publisher has processed this message and sent a response, but the link between the publisher and subscriber fails. As a result, the subscriber does the not receive the response. As described in the section “Message retries”, this causes the subscriber to resend the message. Thus the publisher receives a duplicate updateSubscriptionMap message from the subscriber. Since retries are idempotent, the publisher simply sends back a response to the subscriber. When the subscriber to publisher link fails, it is handled similarly.

Occasionally, POID/INSTANCE is deleted from the publisher, and the subscriber usually does not get notified of this event. Thus, when the subscriber sends an updateSubscriptionMap request concerning a POID/INSTANCE that no longer exists in the publisher, the publisher comes back with an <unknownPID> entity in the response. This tells the subscriber to update its image of the subscription map.

Occasionally, a SOID/INSTANCE is deleted at the subscriber; in general, the publisher has no way of knowing it. On data change, the publisher sends an update request to the deleted SOID/INSTANCE; when this happens, the subscriber sends a <deleteFromSubscriptionMap> entity in its response to notify the publisher of the SOID/INSTANCE deletion. This tells the publisher to update its subscription map.

One catastrophic form of failure is when a publisher loses its subscription map or the subscriber loses its subscription data. This can cause various levels of data loss. For example, if the publisher has experienced a catastrophic failure, such as disk crash, the publisher needs to revert to data from a back up medium such as tape. As a result, its subscription map is out of date. For the subscriber, a similar situation makes its subscribed data out of date. In such an event, the service that experienced the loss sends a message requesting an update. The publisher's subscription map can be brought up to date by the information stored in subscriptions table in the subscriber, while a subscriber's data can be made up to date by the subscription map and the change number stored in the publications table.

In general, the service that experienced the loss has enough knowledge to send a message requests an update. The publisher's subscription map can be brought up to date by the information stored in SUBSCRIPTIONS table in the subscriber. A subscriber's data can be made up to date by the subscription map and the publisher's change number stored in the PUBLICATIONS table.

The following describes the pseudo code for implementing key aspects of publisher and subscriber protocol handlers. Note that to avoid repetition and for brevity, separate flow diagrams are not provided to secondarily represent this pseudocode.

When the service or cluster starts up or is going through an orderly shutdown it sends out status messages to all connected services.

ServiceStartup( )
{

serviceStatusRequest request;
request.entity = “<startup/>”;
## SELECT SID FROM CONNECTIONS
for (each SID in result set)
{

Send(SID,request);

}

}
ServiceShutdown( )
{

serviceStatusRequest request;
request.entity = “<shutdown/>”;
## SELECT SID FROM CONNECTIONS
for (each SID in result set)
{

Send(SID,request);

}

}

When the update interval timer goes off at the subscriber or publisher, it takes actions implied by the following pseudo-code. Note that the ProcessQueue routine is implemented differently by subscribers and publishers:

OnIntervalTimer( )
{

// get a list of all live connections
## SELECT SID, RETRY FROM CONNECTIONS
for (each SID in result set)
{

if (RETRY < RetryCount)
{

// more retries left. process messages in the queue
// for this SID. The topics collection is stored in the
// standard XML system configuration document
for (TOPIC in TOPICS)

ProcessQueue(SID, TOPIC);

}
else if (RETRY < ResetInterval)
{

// retry count exceeded; see if it's time to check for alive-
ness
## UPDATE CONNECTIONS
## SET RETRY = RETRY + 1
## WHERE SID = %SID%

}
else
{

// check for alive-ness by starting another series of retries
## UPDATE CONNECTION
## SET RETRY = 0
## WHERE SID = %SID%

}

}

}

Service Status Messages

When a publisher or a subscriber receives a ServiceStatusMessage the following code is executed:

OnServiceStatus(SID, requestMessage)
{

serviceStatusResponse response;
// if serviceStatus is online
if (requestMessage.entity == “<online/>”)
{

// reset retry count to zero
## UPDATE CONNECTIONS
## SET RETRY = 0
## WHERE SID = %SID%
response.entity = “<online/>”;
Send(SID, response);

}
else if (requestMessage.entity == “<offline/>”)
{

// resent retry count to maximum
## UPDATE CONNECTIONS
## SET RETRY = %RetryCount%
## WHERE SID = %SID%

}

}

When the data changes occur in the publisher, actions implied by the following pseudo-code are taken:

OnDataChanged(PUID, PINST, PCN, TOPIC)
{

// PUID/PINST is the user id whose data was changed. Query the publications
// table for all SUIDs that are affected, and insert this data into
// the PUBLICATIONS_QUEUE, if it does not exist already.
## SELECT PKEY FROM PUBLICATIONS
## WHERE POID = %POID%
## AND PINST = %PINST% AND TOPIC = %TOPIC%
for (each PKEY in the result)
{

| ## IF NOT EXISTS ( | |
|---|---|
| ## | SELECT * FROM PUBLICATIONS_QUEUE |
| ## | WHERE PUBLICATIONS.PKEY=%PKEY%) |

| ## | INSERT INTO PUBLICATIONS_QUEUE |
|---|---|
| ## | (PKEY, PCN) VALUES (%PKEY%, %PCN%) |
| ## ELSE | |
| ## | UPDATE PUBLICATIONS_QUEUE SET PCN=%PCN% |
| ## | WHERE PUBLICATIONS_QUEUE.PKEY = %PKEY% |

}

}

When the update interval timer goes off at the publisher, it takes actions implied by the following pseudo-code:

ProcessQueue(SSID, TOPIC)
{

UpdateSubscriptionDataRequest request;
// select requests in the queue for this SSID; group them by
// PUID followed by ROLE. The rows in each group will result
// in one updateSubscriptionData message
## SELECT POID, PINST, SOID, SINST, ROLE, PCN
## FROM PUBLICATIONS_QUEUE PQ JOIN PUBLICATIONS P
## ON PQ.PKEY = P.PKEY
## WHERE SSID = %SSID AND PQ.TOPIC = %TOPIC%
## GROUP BY POID, PINST, ROLE
for (each group of rows in the result set)
{

// gather up data for the per-topic part of this message
data = GenerateTopicData(POID, PINST, ROLE, TOPIC)
// generate an updateSubscriptionData message
request += GenerateMessage(group, data);

}
// Send request to the subscriber
Send(SSID, request);
// Assume the worst and age the connection
## UPDATE CONNECTIONS
## SET RETRY = RETRY + 1
## WHERE SID = %SSID%

}

When a publisher receives an UpdateSubscriptionMap message, actions implied by the following pseudo-code are taken:

OnUpdateSubscriptionMap(SSID, requestMessage)
{

| | |
|---|---|
| UpdateSubscriptionMapResponse | response; |

// Mark this connection as live
## UPDATE CONNECTIONS
## SET RETRY = 0
## WHERE SID = %SSID%
// the request can have multiple entities. Loop for each
for (each entity in requestMessage)
{

// See if the POID, PINST of the <publisher> is known
if (LookUpUser(POID, PINST))
{

// new subscription
if (entity == ″<addToSubscriptionMap>″)
{

addToSubscriptionMap(SSID, entity, response, TOPIC);

}
else if (entity == ″<deletedFromSubscriptionMap>″)
{

deleteFromSubscriptionMap(SSID, entity, response, TOPIC);

}// deleteFromSubscriptionMap

}
else
{

// append an ″unknown PUID entity to response
response+=″<unknownPUID publisher=’″+POID+″’

instance=’″+PINST+″’/>″;

}

}
Send(SSID, response);

}
// Helper routine to handle add subMessage
addToSubscriptionMap(SSID, subMessage, response, TOPIC)
{

response += ″<addedToSubscriptionMap ″;
response +=″subscriber=’″+SOID+″’instance=’″=SINST+″’/>″;
// the request can have multiple entities. Loop for each
// determine role of the subscriber
for (sub in subMessage)
{

| ROLE = FindRole(POID, PINST, SOID); | |
|---|---|
| ## IF NOT EXISTS | |
| ## (SELECT PKEY | |
| ## FROM PUBLICATIONS | |
| ## WHERE | |
| ## | SOID = %SOID% AND SINST = %SINST% AND |
| ## | POID = %POID% AND PINST = %PINST% AND |
| ## | SSID = %SSID% AND TOPIC = %TOPIC%) |
| ## BEGIN | |
| ## | INSERT INTO PUBLICATIONS VALUES |
| ## | (%POID%, %PINST%, %SOID%, %SINST%, %SSID%, |

%SCN%, %ROLE%, %TOPIC%)

| | |
|---|---|
| | // set an initial message to update this subscriber |
| ## | INSERT INTO PUBLICATIONS_QUEUE VALUES |
| ## | (@@IDENTITY, %PCN%) |
| ## END | |

| ## ELSE | |
|---|---|
| ## BEGIN | |
| ## | UPDATE PUBLICATIONS SET SCN = sub.SCN |
| ## | WHERE |
| ## | SOID = %SOID% AND SINST = %SINST% AND |
| ## | POID = %POID% AND PINST = %PINST% AND |
| ## | SSID = %SSID% AND TOPIC = %TOPIC% AND |
| ## | SCN < sub.SCN |

##END

response +=″<subscription publisher=’″+POID+″’ instance=’″+PINST+″’/>″;

}
// append to the response message
response +=″</addedToSubscriptionMap>″;
}
// Helper routine to handle delete subMessage
deleteFromSubscriptionMap(SSID, subMessage, response, TOPIC)
{
response +=″<deletedFromSubscriptionMap ″;
response +=″subscriber=’″+SOID+″’ instance=’″+SINST+″’/>″
// the request can have multiple entities. Loop for each
for (sub in subMessage)
{

// delete from PUBLICATIONS table. If a non-existent
// row is asked to be deleted, the delete will simply
// return without deleting anything

## SELECT SCN AS STORED_SCN FROM PUBLICATIONS
## WHERE
## SOID = %SOID% AND SINST = %SINST% AND
## SOID = %POID% AND PINST = %PINST% AND
## SSID = %SSID% AND TOPIC = %TOPIC%)
##

| ## IF (result is not empty or STORED_SCN < %SCN%) | |
|---|---|
| ## | DELETE PUBLICATIONS |
| ## | WHERE |
| ## | SOID = %SOID% AND SINST = %SINST% AND |
| ## | POID = %POID% AND PINST = %PINST% AND |
| ## | SSID = %SSID% AND TOPIC = %TOPIC%) |

// NOTE: Are assuming cascade delete on PKEY is set up
response +=″<subscription publisher=’″+POID+″’instance=’″+PINST+″’/>″;

}
// append to the response message
response +=″</deletedFromSubscriptionMap>″;

}

When a publisher receives an UpdateSubscriptionDataResponse message, actions implied by the following pseudo-code are taken:

OnUpdateSubscriptionDataResponse(SSID, response)
{

// Mark this connection as live
## UPDATE CONNECTIONS
## SET RETRY = 0
## WHERE SID = %SSID%
// The response has one entity for each SOID
for (each entity in response)
{

if (entity == ″<updatedData>″)
{

updatedData(SSID, entity, TOPIC);

}
if (entity == ″<deleteFromSubscriptionMap>″)
{

// subscriber did not find SOID/SINST in its SUBSCRIPTIONS table
// publisher should update its subscription map
## DELETE FROM PUBLICATIONS
## WHERE SOID=%SOID% AND SINST=%SINST%

}

}

}
// Helper routine to handle the update subMessage
updatedData(SSID, subMessage, TOPIC)
{

for (sub in subMessage)
{

// publisher needs to check the change number returned in the
// response message and verify if it is valid; if it is, then
// everything is cool; if not, then the subscriber has sent a
// spurious response for a previous request, and so this
// message is ignored
## DELETE FROM PUBLICATIONS_QUEUE
## WHERE PKEY = %PKEY% AND PCN <= %subMessage.PCN%

}

}

When a subscription is added, the actions implied by the following pseudo-code are taken:

{

// check if the publisher has an entry in the CONNECTIONS table for this
// PSID
if (UnknownServiceID(PSID))
{

// no entry exists; send an addSubscription message immediately to
// the publisher.
UpdateSingleSubscriptionMap(SOID, SINST, POID, PINST, PSID, TOPIC, SCN);

}
else
{

| // see if row exists in the subscriptions queue | |
|---|---|
| ## IF EXISTS ( | |
| ## | SELECT SKEY FROM SUBSCRIPTIONS QUEUE |
| ## | WHERE SOID = %SOID% AND SINST = %SINST% |

| | |
|---|---|
| ## | AND POID = %POID% AND PINST = %PINST% |
| ## | AND PSID = %PSID% AND TOPIC = %TOPIC%) |
| ## BEGIN | |

| | |
|---|---|
| ## | UPDATE SUBSCRIPTIONS_QUEUE |
| ## | SET OPERATION = TRUE, SCN = %SCN% |
| ## | WHERE SOID = %SOID% AND SINST = %SINST% |

| | |
|---|---|
| ## | AND POID = %POID% AND PINST = %PINST% |
| ## | AND PSID = %PSID% AND TOPIC = %TOPIC% |
| ## ELSE | |
| ## BEGIN | |

// row does not exist; insert into the queue

| | |
|---|---|
| ## | INSERT INTO SUBSCRIPTION_QUEUE |
| ## | VALUES (%SOID%, %SINST%, %TOPIC%, %POID%, %PINST%, |

TRUE, %SCN%)

## END

}

}
AddSubscription(SOD, SINST, POD, PINST, PSD, TOPIC, SCN)

When a subscription is removed, the subscriber takes actions implied by the following pseudo-code:

RemoveSubscription(SOID, SINST, POID, PINST, PSID, TOPIC, SCN)
{

| // see if row exists in the subscriptions queue | |
|---|---|
| ## IF EXISTS ( | |
| ## | SELECT SKEY FROM SUBSCRIPTIONS QUEUE |
| ## | WHERE SOID = %SOID% AND SINST = %SINST% |

| | |
|---|---|
| ## | AND POID = %POID% AND PINST = %PINST% |
| ## | AND PSID = %PSID% AND TOPIC = %TOPIC%) |
| ## BEGIN | |

| | |
|---|---|
| ## | UPDATE SUBSCRIPTIONS QUEUE |
| ## | SET OPERATION = FALSE, SCN = %SCN% |
| ## | WHERE SOID = %SOID% AND SINST = %SINST% |

| | |
|---|---|
| ## | AND POID = %POID% AND PINST = %PINST% |
| ## | AND PSID = %PSID% AND TOPIC = %TOPIC% |
| ## END | |
| ## ELSE | |
| ## BEGIN | |

// row does not exist; insert into the queue

| | |
|---|---|
| ## | INSERT INTO SUBSCRIPTION QUEUE |
| ## | VALUES (%SOID%, %SINST%, %TOPIC%, %POID%, %PINST%, |

FALSE, %SCN%)

## END

56

When the update interval timer goes off at the subscriber, it takes actions implied by the following pseudo-code:

ProcessQueue(PSID, TOPIC)
{

UpdateSubscriptionMap request;
// select requests in the queue for this PSID; order them by
// PUID then by OPERATION. The rows in each group will result
// in addSubscription and deleteSubscription subMessage
## SELECT * FROM PUBLICATION_QUEUE
## WHERE PSID = %PSID% AND TOPIC = %TOPIC%
## ORDER BY POID, PINST, OPERATION
request += GenerateMessage( );
// Send request to the publisher
Send(PSID, request);
// Assume the worst and age the connection
## UPDATE CONNECTIONS
## SET RETRY = RETRY + 1
## WHERE SID = %SSID%

}

When a subscriber receives a request, the actions implied by the following pseudo-code are performed:

OnUpdateSubscriptionData(PSID, request)
{

UpdateSubscriptionDataResponse response;
// Mark this connection as live
## UPDATE CONNECTIONS
## SET RETRY = 0
## WHERE SID = %PSID%
// request may contain multiple entities
for (each entity in request)
{

for (sub in entity)
{

// check to see if this is a known subscriber
if (LookUpUser(sub.SOID, sub.SINST))
{

// is this a duplicate request message? I can find this by looking
// at change numbers
## SELECT PCN AS STORED_PCN
## FROM SUBSCRIPTIONS
## WHERE POID = %POID% AND PINST = %PINT%
## AND SOID = %SOID% AND SINST = %SINST%
## AND TOPIC = %TOPIC% AND PSID = %PSID%
// result set empty means subscriber does not have
// a subscription on publisher‘s document
if (result set is empty)
{

| // do not send a response for this request. | |
|---|---|
| // send prepare for an unsub request instead | |
| ## IF NOT EXISTS ( | |
| ## | SELECT * FROM SUBSCRIPTIONS QUEUE |
| ## | WHERE POID = %POID% AND PINST = %PINST% |
| ## | AND SOID = %SOID% AND SINST = %SINST% |
| ## | AND TOPIC = %TOPIC% AND %PSID% = %PSID%) |
| ## | BEGIN |

RemoveSubscription(%SOID%,

%SINST%, %POID%, %PINST%,

%PSID%, %TOPIC%, %SCN%);

## END

}
// pcn is the change number present in the message
else
{
if(entity.PCN > STORED_PCN)
{

// This function updates subscribed data
UpdateData(entity);
// update the change number
## UPDATE SUBSCRIPTIONS
## SET PCN = entity.PCN
## WHERE POID = %POID% AND PINST = %PINT%
## AND SOID = %SOID% AND SINST = %SINST%
## AND TOPIC = %TOPIC% AND PSID = %PSID%

}
// append to response
response += ″<updatedData>″;

}
}
else
{

// subscriber is unknown; signal publishing service to delete it
response += ″<deleteFromSubscriptionMap″;
response += ″subscriber=‘″+SOID+″‘ instance=‘″+SINST+″‘/>″;

}

}

}
Send(SSID, response);

}

When a subscriber receives an UpdateSubscriptionMapResponse message, the actions implied by the following pseudo-code are performed:

OnUpdateSubscriptionMapResponse(PSID, request)
{

// Mark this connection as live
## UPDATE CONNECTIONS
## SET RETRY = 0
## WHERE SID = %PSID%
// The response has one entity for each row in subscription queue
for (each entity in response)
{

if (entity == ″<addedToSubscriptionMap>″)
{

for (sub in entity)
{

// publisher successfully added its subscription map
// subscriber now adds to its subscriptions table

| ## IF EXISTS ( | |
|---|---|
| ## | SELECT * FROM SUBSCRIPTIONS QUEUE |
| ## | WHERE POID = %POID% AND PINST = %PINT% |
| ## | AND SOID = %SOID% AND SINST = %SINST% |
| ## | AND TOPIC = %TOPIC% AND PSID = %PSID% |
| ## | AND SCN = %SCN%) |
| ## BEGIN | |
| ## | INSERT INTO SUBSCRIPTIONS |

| | |
|---|---|
| ## | VALUES (%SOID%, %SINST%, %POID%, |

%PINST%, %PSID%, 0,

%TOPIC%)

| // since request has received the proper response, | |
|---|---|
| // it can be deleted from the subscriptions queue | |
| ## | DELETE FROM SUBSCRIPTIONS_QUEUE |
| ## | WHERE POID = %POID% AND PINST = |

%PINT%

| | |
|---|---|
| ## | AND SOID = %SOID% AND SINST = |

%SINST%

| | |
|---|---|
| ## | AND TOPIC = %TOPIC% AND PSID = |

%PSID%

| | |
|---|---|
| ## | AND OPERATION = 1 |
| ## | AND SCN = %SCN% |

## END

}

}
if (entity == ″<deletedFromSubscriptionMap>″)
{

for (sub in entity)
{

// publisher successfully deleted from its subscription map
// subscriber now deletes from its subscriptions table

| ## IF EXISTS ( | |
|---|---|
| ## | SELECT * FROM SUBSCRIPTIONS_QUEUE |
| ## | WHERE POID = %POID% AND PINST = %PINT% |
| ## | AND SOID = %SOID% AND SINST = %SINST% |
| ## | AND TOPIC = %TOPIC% AND PSID = %PSID% |
| ## | AND SCN = %SCN%) |

## BEGIN

| ## | DELETE FROM SUBSCRIPTIONS |
|---|---|
| ## | WHERE POID = %POID% AND PINST = |
| | %PINT% |
| ## | AND SOID = %SOID% AND SINST = |
| | %SINST% |
| ## | AND TOPIC = %TOPIC% AND PSID = |
| | %PSID% |
| // since request has received the proper response, | |
| // it can be deleted from the subscriptions queue | |
| ## | DELETE FROM SUBSCRIPTIONS_QUEUE |
| ## | WHERE POID = %POID% AND PINST = |

%PINT%

| | |
|---|---|
| ## | AND SOID = %SOID% AND SINST = |

%SINST%

| | |
|---|---|
| ## | AND TOPIC = %TOPIC% AND PSID = |

%PSID%

| | |
|---|---|
| ## | AND SCN = %SCN% |

## END

}

}

}

}

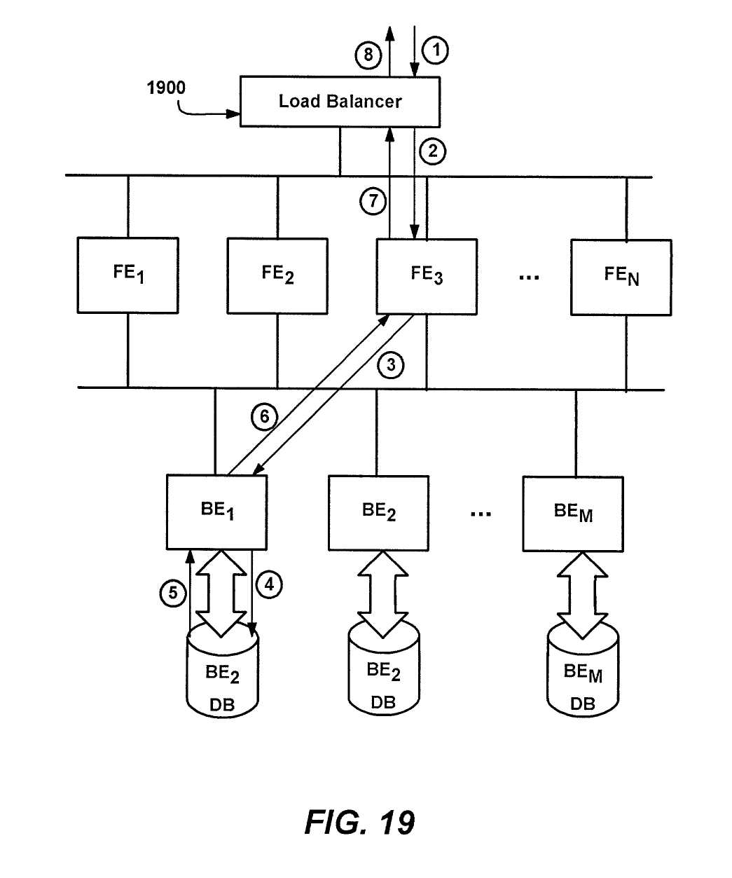

Eventually .NET services are expected to handle hundreds of millions of users. As a result, the implementation should be extremely scalable and fault-tolerant. One way in which this may be achieved is by having multiple clusters, with each cluster having front-end servers and backend servers. In one architecture, every backend server will handle the data for a subset of users. FIG. 19 represents one such cluster architecture.

As represented in FIG. 19, when a request comes in, the load balancer redirects the request to a front end server (FE), based on load balancing and fault-tolerance considerations. The FE does some preliminary processing on the request, locates the back-end server (BE) servicing this user, and forwards the request to the back end server. The BE returns with a response, which the FE puts into an appropriate message format (e.g., .NET data language) and sends it off to its destination. Note the as a result from this architecture, the FEs are stateless; they carry no memory of previous .NET data language requests. As a result, any FE can handle any given request. Thus, two messages bound for the same BE can be processed by two different FEs. Further, because FEs are stateless, the load-balancer, on an incoming request, can distribute load by choosing an FE which is not busy. The same property allows the load balancer to be fault-tolerant when an FE fails. The BE is stateful; when required by the semantics of a service, the BE remembers history. Moreover, each BE services a subset of the users of the entire service, and while the choice of an FE is arbitrary, a given request always corresponds to one specific BE—the one which stored the user's data.

In FIG. 19, the arrows labeled with circled numerals one (1) through eight (8) represent the data flow on a typical request, with (1), a request comes to the service's load balancer 1900. Then, the load balancer determines that FE₃ is the right front-end to handle this request (based on load and failover considerations), and (2) provides the request to FE₃ which processes the request. FE₃ determines the user identity, and locates the BE that services this user, which in the present example, is BE₁. FE₃ determines what data is needed from the backend, and FE₃ sends database requests to BE₁ (arrow labeled three (3)).

In turn, BE₁ retrieves the required data from the database (arrows labeled four (4) and five (5)), and BE₁ sends data back to FE₃, in the form of database response (arrow six (6)). Then, FE₃ returns the data back into an appropriate response and sends the message off to its destination (arrows labeled seven (7) and eight (8)).

The model represented in FIG. 19 works fine for handling incoming SSCP requests. For example, when an updateSubscriptionMap request comes into a publisher, it is processed in the general manner described above. However, for outgoing requests, such as when the publisher needs to send the updateSubscriptionData message, an enhanced model is provided, generally because in the SSCP protocol, a publisher or a subscriber processes its queue every time the interval timer goes off, and for the protocol to function correctly, a single reader should drain the queue, and also because in the model described in the previous section, the BE has no reason to initiate a request message; its job is to process a request and generate an appropriate response. However, SSCP requires that the participating services generate requests when the interval timer goes off:

a) A publisher sends updateSubscriptionData messages

b) A subscriber sends updateSubscriptionMap messages

This is handled as below, wherein for the purposes of this description, the word “service” refers to either the publisher or the subscriber, and the word “queue” refers to either the publication queue or the subscription queue. To enhance the model, the FEs run code for inbound SSCP messages, just as they do for other inbound .NET data language messages. This means that the FEs run code for updating subscription data (on the subscribing side), code for updating subscription maps (on the publishing side), and processing SSCP responses (both subscriber and publisher).

The BEs run code for outbound SSCP messages. This code runs every time the interval timer goes off. This code handles the publication queue and generating updateSubscriptionData messages (publisher), handling subscription queue and generating updateSubscriptionMap messages (subscriber). The process generally works as follows:

1) Each BE stores a slice of the persistent SSCP data. Taking the example of a publishing service, if BE1 manages user₁₁ and user₁₂, and BE₂ manages user₂₁ and user₂₂ then BE₁ stores PUBLICATIONS and PUBLICATIONS_QUEUE and CONNECTION tables which handle the subscription/publication requirements for data from user₁₁ and user₁₂. BE₂ stores PUBLICATIONS and PUBLICATIONS_QUEUE and CONNECTION tables which handle the sub/pub requirements for data from user₂₁ and user₂₂.

2) When the interval timer goes off at a service, each BE wakes up to process its queue.

3) If the queue is not empty, then the BE constructs the appropriate message(s)—such as updateSubscriptionData, or updateSubscriptionMap. For each message:

a) The BE picks an FE (e.g., at random) and sends the message to it.

b) The FE simply forwards the message along to its destination—i.e., it acts as a proxy.

c) A response is handled in the usual way (since incoming SSCP messages don't require any changes)

FIG. 20 generally represents this model when the interval timer goes off and the following things happen at BE₁ (similar things also happen at other BEs). Assume that BE₁ has to send two requests, request1 and request2, as a result of processing its queue during this interval timer event. In the arrows labeled (A), BE₁ sends request1 through FE₃, which is randomly picked. The arrows labeled (B) represent a response arriving from a destination service through FE₂, which is picked by the load balancer according to its algorithms. The arrows labeled (C) represent BE sending request2 through randomly picked FE₁. The arrows labeled (D) represent a response arriving from a destination service through FE₁ (which is picked by the load balancer according to its algorithms).

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computer network, a system comprising,
a first service for providing access to data based on an associated identity of each user;
a second service for providing access to data based on an associated identity of each user; and
a communications mechanism configured to exchange information between the first service and the second service, the first service configured as a publisher of change data made by users via the first service, and the second service configured as a subscriber of the change data, the communications mechanism communicating change information of the first service to the second service including determining the role of each subscribing user and filtering the data based on each determined role.
